(19) United States
(12) Patent Application Publication
(10) Pub. No.: US 2025/0258634 A1
(43) Pub. Date: Aug. 14, 2025

(54) STORAGE MEDIUM STORING APPLICATION PROGRAM, METHOD, AND INFORMATION PROCESSING APPARATUS

(71) Applicant: CANON KABUSHIKI KAISHA, Tokyo (JP)

(72) Inventor: TSUBASA OCHIAI, Chiba (JP)

(21) Appl. No.: 19/045,047

(22) Filed: Feb. 4, 2025

(30) Foreign Application Priority Data
Feb. 8, 2024 (JP) 2024-017707

(51) Int. Cl. G06F 3/12; H04N 1/405

(52) U.S. Cl. CPC G06F 3/1258; G06F 3/1205; H04N 1/405

(57) ABSTRACT

A storage medium storing an application program causing a computer of an information processing apparatus to execute a control method including accepting setting related to calibration, instructing a printing apparatus connected to the information processing apparatus to execute the calibration in accordance with the setting, obtaining capability information of the printing apparatus, determining whether the printing apparatus includes a module using a calibration result based on the capability information, generating print data based on intermediate data generated by general-purpose print software without correction when the printing apparatus includes a module using the calibration result, generating print data based on corrected intermediate data that is obtained by correcting the intermediate data using the calibration result obtained from the printing apparatus when the printing apparatus does not include a module using the calibration result, and sending the print data generated to the printing apparatus.

### BACKGROUND

### Field of the Disclosure

The present disclosure relates to a storage medium storing an application program, a method, and an information processing apparatus.

### Description of the Related Art

There is a known configuration to issue a print instruction to a printing apparatus connected to the host computer while using a printer driver installed in the host computer as control software for the printing apparatus. An OS (Operating System), which is basic software, is installed in the host computer, and the printer driver is configured in accordance with a specification defined by the OS and is called from the OS to operate. On the other hand, a vendor that provides a printing apparatus can provide a means for instructing the printing apparatus to print using the OS by providing a printer driver that conforms to the specification of the OS. In the present specification, a vendor includes a manufacturer of a printing apparatus.

In recent years, Windows (registered trademark) has provided a standard class driver (hereinafter, also referred to as a “standard driver”) that can be used in common among printing apparatuses provided by vendors. The standard driver is packaged in the OS package, and an arbitrary printing apparatus can be easily usable by connecting to a host computer. Therefore, the standard driver is highly convenient because it is not necessary to separately install a model-specific printer driver suitable for a printing apparatus. The standard driver is configured to be able to designate a print function in accordance with a Print Device Capabilities (hereinafter, also referred to as a “PDC”) generated based on information obtained from the connected printing apparatus. This enables a user using the standard driver can designate a print function corresponding to capability of a connected printing apparatus even though the user uses one standard driver.

However, since functions that can be designated by a user are limited to functions that can be achieved only by the standard driver, the user cannot designate a vendor-specific function. In view of this, Japanese Patent Laid-Open Publication No. 2019-074906 (Counterpart of U.S. patent Ser. No. 10/747,481 B2) discloses a technique of expanding functions so as to achieve a page layout function, which is one of vendor-specific functions, by an expansion application associated with the standard driver.

In addition, conventionally, it is considered to execute a calibration function, which is one of vendor-specific functions, by an expansion application associated with the standard driver. The calibration function is a function of generating a correction coefficient for correcting unique characteristics of a printing apparatus or actually performing correction. For example, when a user prints using a calibration function relating to a gamma characteristic of a printing apparatus, a printed matter having the same gradation as that under an original environmental condition can be obtained even when the environmental condition changes.

However, if the image correction using the calibration result obtained from the printing apparatus is always executed by the expansion application in the host computer, there is a concern that the performance of the host computer may be degraded. In general, a printing apparatus performs image correction by an electronic circuit such as an ASIC designed to be able to execute an image process at high speed. Therefore, the performance is more likely to be degraded in the case where the host computer executes the image process as compared with the case where the printing apparatus executes the image process.

On the other hand, even if the printing apparatus is caused to perform image correction using the calibration result in consideration of performance degradation, a module for performing the corresponding image correction may not be installed in the printing apparatus due to an issue such as product cost. In such a case, the printing apparatus cannot provide the calibration function in printing using the standard driver. In addition, when a correction module is newly installed in the printing apparatus in order to provide the calibration function, the cost of the printing apparatus increases.

### SUMMARY

Embodiments of the present disclosure provide a mechanism that improves the performance of correction based on a calibration result when a printing apparatus supported by general-purpose print software includes a module that uses the calibration result, and enable the correction even when the printing apparatus does not include the module.

Embodiments of the present disclosure provide a non-transitory computer-readable storage medium storing an application program causing a computer of an information processing apparatus, which executes general-purpose print software capable of generating print data printable by printing apparatuses provided by different vendors, to execute a control method including accepting setting related to calibration, instructing a printing apparatus connected to the information processing apparatus to execute the calibration in accordance with the setting related to the calibration, obtaining capability information of the printing apparatus, determining whether the printing apparatus includes a module that uses a result of the calibration based on the capability information of the printing apparatus, generating print data based on intermediate data generated by the general-purpose print software without correcting the intermediate data in a case where the printing apparatus includes a module that uses the result of the calibration, generating print data based on corrected intermediate data that is obtained by correcting the intermediate data using the result of the calibration obtained from the printing apparatus in a case where the printing apparatus does not include a module that uses the result of the calibration, and sending the print data generated to the printing apparatus.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a print system.

FIGS. 2A and 2B are diagrams illustrating software configurations of the print system.

FIG. 3 is a flowchart illustrating a calibration process performed by the printing apparatus.

FIG. 4 is a view illustrating an example of a density pattern.

FIG. 5 is a view illustrating an example of an effect of a calibration function.

FIG. 6A is a view illustrating an example of a print setting screen.

FIGS. 6B and 6C are views illustrating examples of advanced setting screens in a first embodiment.

FIG. 7 is a flowchart illustrating a PDC editing process performed by a print function expansion unit of an expansion application.

FIGS. 8A and 8B are views illustrating examples of lists of capability information obtained from the printing apparatus in the first embodiment as tables.

FIG. 9 is a view illustrating an example of a list of print functions supported by the expansion application in the first embodiment as a table.

FIG. 10 is a view illustrating an example of a list of print functions supported by a general-purpose print software.

FIG. 11A is a sequence chart illustrating operations of a drawing application, the general-purpose print software, the expansion application, and the printing apparatus in the first embodiment.

FIG. 11B is a sequence chart illustrating operations of the drawing application, the general-purpose print software, the expansion application, and the printing apparatus in the first embodiment.

FIG. 11C is a flowchart in which a flow from a step S1119 to a step S1123 in the sequence charts in FIGS. 11A and 11B is summarized while focusing the expansion application.

FIG. 12 is a view illustrating a software configuration of the print system when the expansion application is associated with the general-purpose print software and the printing apparatus in a second embodiment.

FIGS. 13A and 13B are views illustrating examples of lists of capability information obtained from the printing apparatus in the second embodiment as tables.

FIG. 14 is a view showing an example of a list of print functions supported by the expansion application in the second embodiment as a table.

FIGS. 15A and 15B are views respectively illustrating examples of a print setting screen and an advanced setting screen in the second embodiment.

FIG. 16 is a sequence chart illustrating operations of the drawing application, general-purpose print software, expansion application, and printing apparatus in the second embodiment.

FIG. 17 is a view illustrating a software configuration of the print system when the expansion application is associated with the general-purpose print software and the printing apparatus in a third embodiment.

FIGS. 18A and 18B are views illustrating examples of lists of capability information obtained from the printing apparatus in the third embodiment as tables.

FIG. 19 is a view illustrating an example of a list of print functions supported by the expansion application in the third embodiment as a table.

FIGS. 20A and 20B are views respectively illustrating examples of a print setting screen and an advanced setting screen in the third embodiment.

FIG. 21A is a sequence chart illustrating operations of the drawing application, general-purpose print software, expansion application, and printing apparatus in the third embodiment.

FIG. 21B is a sequence chart illustrating operations of the drawing application, general-purpose print software, expansion application, and printing apparatus in the third embodiment.

FIG. 22 is a view illustrating an example of a warning screen displayed on the display device.

### DESCRIPTION OF THE EMBODIMENTS

Hereafter, embodiments according to the present disclosure will be described in detail by referring to the drawings. However, configurations described in the following embodiments are merely examples, and the scope of the present disclosure is not limited by the configurations described in the embodiments. For example, not all combinations of features described in the embodiments are necessarily essential to the solving means of the present disclosure. For example, each unit constituting the present disclosure can be replaced with any configuration capable of exhibiting the same function. In addition, an arbitrary constituent may be added. Any two or more configurations (features) of the embodiments can be combined. In second and third embodiments, the same configurations and processes as those of a first embodiment are denoted by the same reference numerals, and the description thereof will be omitted.

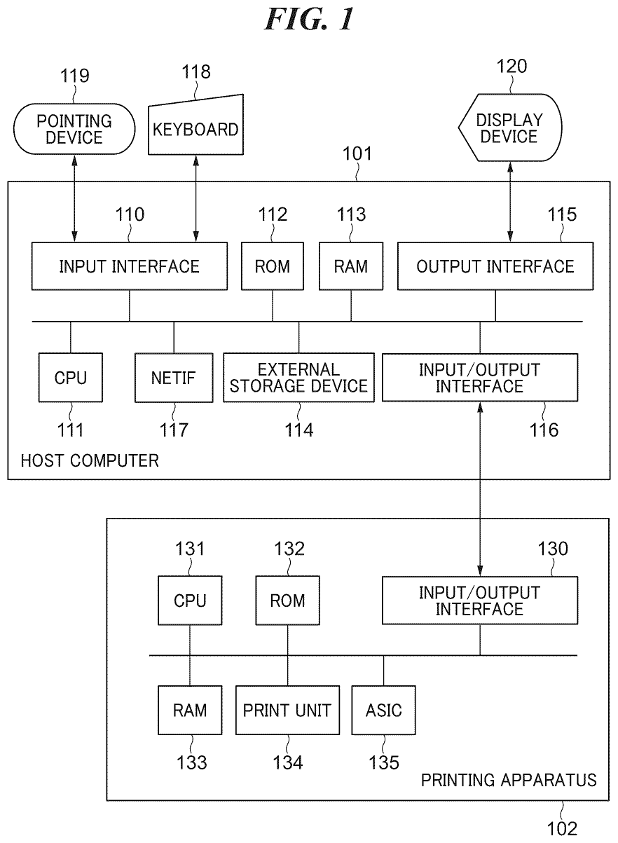

The first embodiment will now be described with reference to FIGS. 1 to 11C.

FIG. 1 is a block diagram illustrating a hardware configuration of a print system. As illustrated in FIG. 1, the print system includes a host computer 101 and a printing apparatus 102. The host computer 101 (an information processing apparatus) may be a desktop personal computer, a smartphone, a notebook personal computer, or a tablet terminal. In FIG. 1, the host computer 101 has an input interface 110, a CPU 111, a ROM112, a RAM113, an external storage device 114, an out interface 115, an in/out interface 116, and a network interface 117. The input interface 110 is connected to input devices, such as a keyboard 118 and a pointing device 119, and the output interface 115 is connected to a display device 120.

For example, a print setting screen, an advanced setting screen, etc., which will be described later, are displayed on the display device 120. The network interface 117 controls data transfer with an external apparatus via a network. The ROM 112 stores an initialization program etc. The external storage device 114 stores an application program group, an operating system (OS), print data generation software, and other various data. The RAM 113 is used as a work memory when executing various programs stored in the external storage device 114. In this way, various programs can operate in the host computer 101. In the first embodiment, the CPU 111 performs processes in accordance with procedures of programs stored in the ROM 112, whereby the host computer 101 executes functions described later and processes illustrated in flowcharts and sequence charts described later.

The printing apparatus 102 is connected to the host computer 101 via the input/output interface 116. The printing apparatus 102 includes an input/output interface 130, a CPU 131, a ROM 132, a RAM 133, a print unit 134, and an ASIC 135. The input/output interface 116 of the host computer 101 is connected to the input/output interface 130. The CPU 131 controls the entire printing apparatus 102. The ROM 132 stores a control program of the printing apparatus 102 and the like. The RAM 133 provides a memory area for temporarily storing various information when the CPU 131 executes the program. The print unit 134 forms an image on a sheet by an electrophotographic method. However, the print unit 134 is not limited to this, and may be an apparatus using another process such as an inkjet method. The ASIC 135 executes an image process, a process relating to calibration described later, etc. The printing apparatus 102 may be a multifunction peripheral having a plurality of functions, such as copy, print, and facsimile. Although the host computer 101 and the printing apparatus 102 are separately configured in this embodiment, they may be configured as one apparatus.

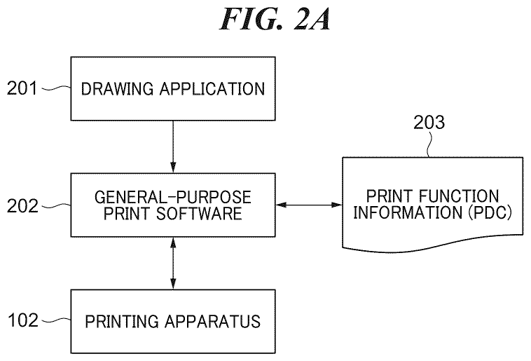

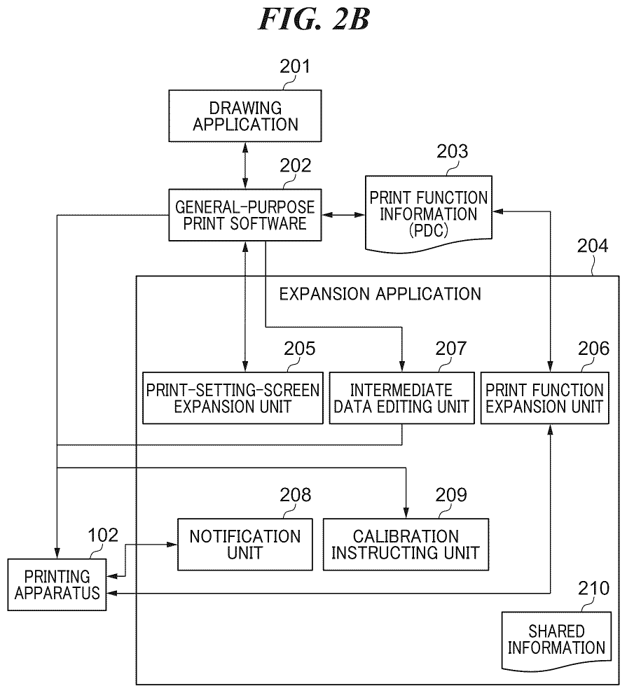

FIGS. 2A and 2B are diagrams illustrating software configurations of the print system. The following description is based on the print system using the host computer 101 on which Windows (registered trademark) 11 of Microsoft (registered trademark) is installed as the OS. FIG. 2A shows a drawing application 201, general-purpose print software 202, and print function information 203 as a general software configuration of the print system. FIG. 2B shows an expansion application 204 in addition to the general software configuration of the print system illustrated in FIG. 2A. That is, FIG. 2A is the diagram showing the general configuration in which the expansion application 204 is not associated with the general-purpose print software 202 and the printing apparatus 102. FIG. 2B shows the configuration in which the expansion application 204 is associated with the general-purpose print software 202 and the printing apparatus 102. The drawing application 201, the general-purpose print software 202, the print function information 203, and the expansion application 204 are stored in the external storage device 114 of the host computer 101.

First, the software configuration of the print system in which the expansion application 204 is not associated with the general-purpose print software 202 and the printing apparatus 102 will be described with reference to FIG. 2A. The drawing application 201 is software for generating contents (drawing data) to be printed. The drawing application 201 corresponds to, for example, a document creation application, a spreadsheet application, or the like. Upon receiving a print request from a user, the drawing application 201 issues a print instruction to the OS. The print instruction includes print setting information for instructing operations of the general-purpose print software 202 and the printing apparatus 102. The print setting information is also referred to as a Print Ticket (hereinafter, referred to as a “PT”).

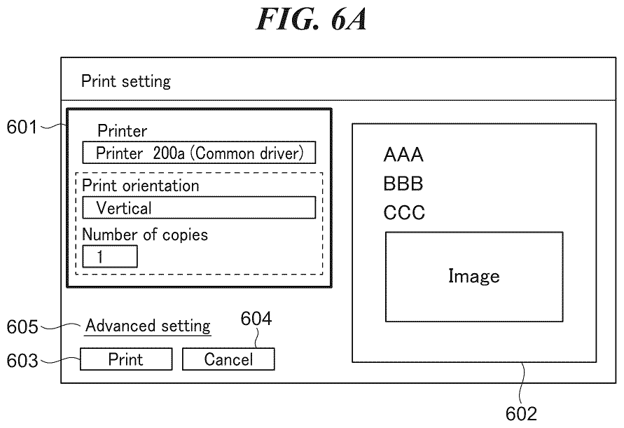

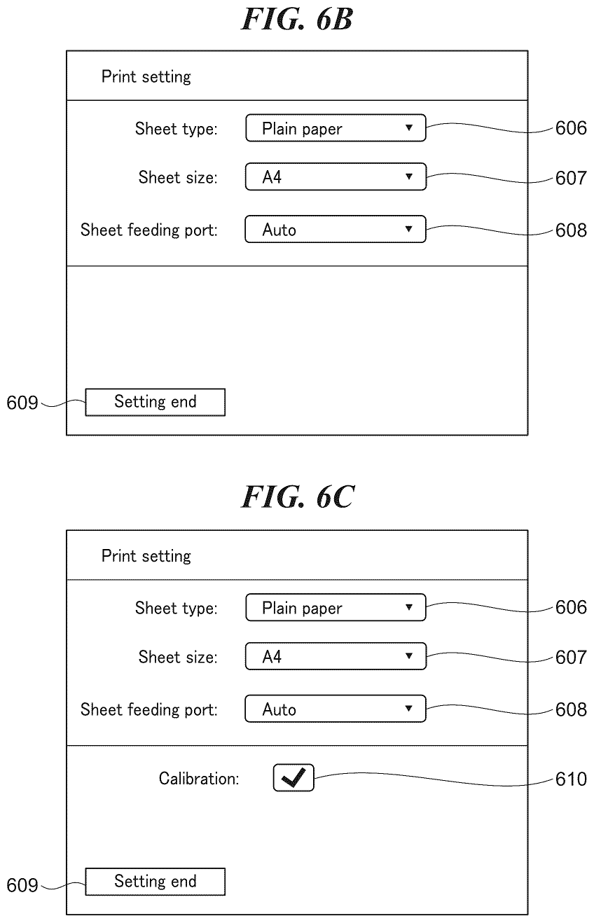

The drawing application 201 can display a print setting screen provided by any of the general-purpose print software 202, the OS, and the drawing application 201 in order to output a PT. When an advanced setting button in the print setting screen is selected, the general-purpose print software 202 additionally displays an advanced setting screen. Details of the print setting screen and the advanced setting screen will be described later with reference to FIGS. 6A, 6B, and 6C. The advanced settings screen includes setting items (hereinafter also referred to as “controls”) indicating print functions that can be set by a user in accordance with capability information of the general-purpose print software 202 and controls indicating set values thereof. The capability information is also called Print Capabilities (hereinafter, referred to as “PC”).

The general-purpose print software 202 is a software program capable of generating print data printable by a plurality of printing apparatuses provided by different vendors. The general-purpose print software 202 determines a PC based on the print function information 203. The print function information 203 is data indicating all print functions that can be set by a user, the set values thereof, and print functions in which the exclusive relationship between the set values is described. The print function information 203 is also called PDC (Print Device Capabilities). Hereinafter, the print capability information 203 is referred to as “PDC 203”. The PDC 203 is included in a configuration file of the general-purpose print software 202 that is stored in the external storage device 114 of the host computer 101 as an unchangeable file. Alternatively, the PDC 203 can be dynamically generated by the general-purpose print software 202 or the like. Specifically, the general-purpose print software 202 or the OS can be configured to obtain attribute data of the printing apparatus 102 from the printing apparatus 102 and generate the PDC 203 in accordance with the attribute information in the obtained attribute data. When the PDC 203 is dynamically generated, the generated PDC 203 can be edited.

The attribute data of the printing apparatus 102 is a response obtained by issuing a Get-Printer-Attributes operation of IPP (Internet Print Protocol) to the printing apparatus 102. The response includes the attribute information indicating functions that can be designated in the printing apparatus 102 and set values associated with the attribute information. This response is stored in the RAM 113. With this configuration, the general-purpose print software 202 can be configured so that the user can designate print functions available in the respective printing apparatuses connected to the host computer 101. That is, even when printing apparatuses having different functions or printing apparatuses developed by different vendors are connected, the general-purpose print software 202 can be configured such that the user can designate a print function usable in each of the connected printing apparatuses. The vendor may be a manufacturer of a printing apparatus as described above.

Here, a configuration using an IPP Class Driver installed in Windows (registered trademark) 11 as the general-purpose print software 202 will be described. The IPP class driver is a printer driver that executes a print process in accordance with the specification of a standard print protocol called IPP, and is included in the package of the OS. The IPP class driver is not a unique printer driver corresponding to the model of the printing apparatus 102, but is a standard class driver that can be used in common among a plurality of printing apparatuses.

The IPP class driver obtains the capability information of the connected printing apparatus 102 and generates the PDC 203 based on the information so that the user can designate a print function supported by the connected printing apparatus 102. However, the IPP class driver does not support the calibration function and the correction function using the calibration result. This is because the two functions are functions unique to the vendor. Therefore, four points including the calibration function, a use case of the calibration function, a flow of the calibration process, and an effect of the calibration function will be described below.

First, the calibration function will be described. The calibration function is a function of generating a correction coefficient for correcting unique characteristics of the printing apparatus 102 or actually performing correction. In the following description, the calibration function for correcting the gamma characteristic will be described, but the present disclosure is not limited thereto. In the present disclosure, the calibration function may be a function of correcting the unique characteristics of the printing apparatus 102, such as color shift, color tone, inclination of laser, or head shift of an ink jet printer. In the calibration for correcting the gamma characteristic, the printing apparatus 102 outputs a density pattern, reads the density from the output pattern, and generates a gamma coefficient for correcting a deviation from a reference value. Thereafter, when printing image data, the printing apparatus 102 corrects image data using the gamma coefficient generated by calibration and prints the corrected image data, thereby always printing image data with the same gradation.

Analog characteristics of the printing apparatus 102 change due to various factors. And even when the same image data is printed, the gradation may vary depending on an output timing. For example, factors that change the analog characteristics include wear of the print unit 134 constituting the printing apparatus 102 and a change in environmental conditions. In such a case, the user can always obtain the printed matter having the same gradation even when the printing unit is consumed or the environmental condition is changed by printing using the calibration function.

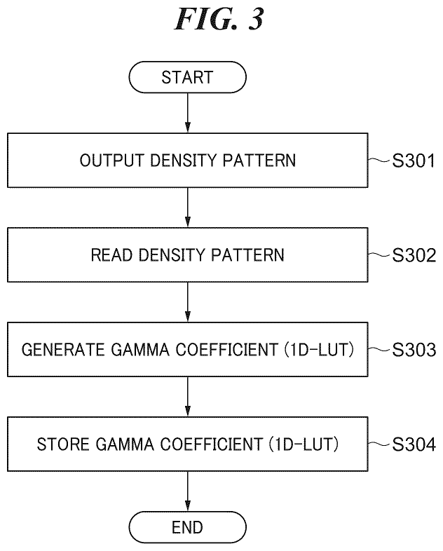

Next, the flow of the calibration process performed by the printing apparatus 102 will be described using a flowchart illustrated in FIG. 3. Note that each step of the flowchart illustrated in FIG. 3 is implemented by the ASIC 135 in the printing apparatus 102, but may be implemented by the CPU 131 reading a program stored in the ROM 132 to the RAM 133 and executing it. First, in a step S301, the ASIC 135 outputs a density pattern. Thus, in the printing apparatus 102, the density pattern is printed on an intermediate transfer belt or a sheet (not illustrated).

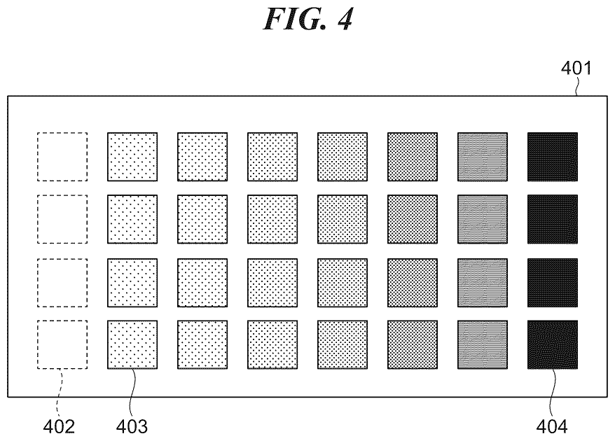

Here, the density pattern will be described with reference to FIG. 4. FIG. 4 is a view showing an example of the density pattern. In the density pattern 401, paper white regions 402 and gradation data from patches 403 to solid patches 404 are continuously arranged from the left to the right. The density pattern 401 is formed of the respective colors of C, M, Y, and K from the top. In the case of correction of color shift or color tone, other patches may be output.

Referring back to the description of FIG. 3. Next, in a step S302, the ASIC 135 reads the density pattern 401 printed in the step S301 with a sensor (not illustrated) to obtain signal values. Subsequently, in a step S303, the ASIC 135 compares the signal values of the read density pattern 401 with target values stored in advance, and generates a gamma coefficient (1D-LUT) that minimizes the differences between the signal values and the target values. Finally, in a step S304, the ASIC 135 stores the generated gamma coefficient (1D-LUT) in the ASIC 135. Thereafter, the flowchart illustrated in FIG. 3 is terminated.

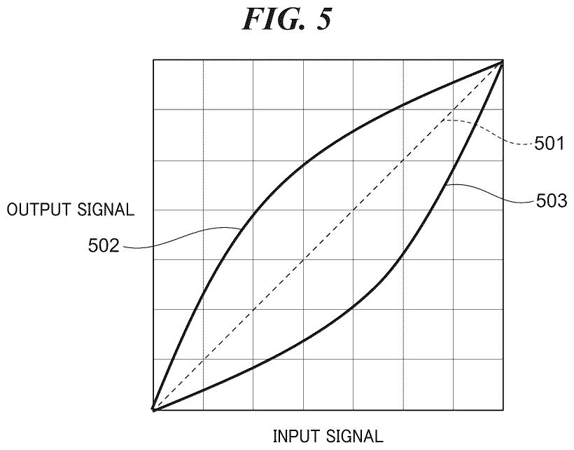

Next, the effect of the calibration function will be described with reference to FIG. 5. In FIG. 5, a horizontal axis represents an input signal value and a vertical axis represents an output signal value. A broken line 501 indicates the target values of the tone, a solid line 502 indicates the output signal values read from the patches in the step S302, and a solid line 503 indicates the gamma coefficient (1D-LUT) generated in the step S303. In FIG. 5, the output result of the patches (solid line 502) has an upwardly convex characteristic as compared with the target values (broken line 501), and therefore, the gamma coefficient (solid line 503) has a downwardly convex characteristic in order to match the output result of patches (solid line 502) to the target values (broken line 501).

The printing apparatus 102 performs the image correction using the gamma coefficient generated by the calibration function, and thus can always perform printing with a gradation as targeted even when there is wear of the printing unit or a change in environmental conditions. However, the calibration function is a vendor-specific function as described above, and therefore is not displayed on the advanced setting screen displayed by the general-purpose print software 202. That is, when using the IPP class driver, the user cannot select the calibration function, and cannot perform printing using the calibration function.

Referring back to the description of FIG. 2A. When a print instruction is issued from the drawing application 201, a module of the OS in the general-purpose print software 202 generates intermediate data. The data output for printing by the drawing application 201 is data in the Graphic Device Interface format (data in the GDI format) or data in the XML Paper Specification format (data in the XPS format). Here, an IPP class driver shall be used as the general-purpose print software 202. In this case, when the data output from the drawing application 201 is data in the GDI format, the OS converts the data in the GDI format output from the drawing application 201 into data in the XPS format. The intermediate data includes drawing data that is information of an image to be formed on a sheet and a PT set by the user.

The general-purpose print software 202 converts the generated intermediate data into print data that can be interpreted by the printing apparatus 102, and transmits the print data to the printing apparatus 102. Here, the print data is a PDL (Page Description Language) data conforming to the IPP. The PDL data conforming to the IPP is, for example, data in a PDF (Portable Document Format) or a PWG-Raster format. The print data includes a drawing data that is information about an image formed on a sheet and print setting attribute information (attribute information designating print setting) generated based on the PT set by the user. The print setting attribute information includes attribute information indicating functions that can be designated by the printing apparatus 102 and set values associated with the attribute information.

The printing apparatus 102 performs printing on a sheet based on the print data sent from the general-purpose print software 202. At this time, the printing apparatus 102 forms the drawing data included in the print data on a sheet by an operation according to the print setting attribute information included in the print data. The print setting attribute information includes the attribute information for designating print quality (image quality priority, speed priority, etc.), double-sided printing, etc., and set values thereof. For example, when the print setting attribute information includes attribute information designating the double-sided printing and a set value indicating that the double-sided printing is to be operated, the printing apparatus 102 executes the double-sided printing.

Next, the software configuration of the print system in which the expansion application 204 is associated with the general-purpose print software 202 and the printing apparatus 102 will be described with reference to FIG. 2B. Note that the configuration and process not particularly mentioned below are the same as those in FIG. 2A. The expansion application 204 is software for expanding the function of the general-purpose print software 202, and is software that is not included in the OS in advance (not packaged together).

As such, the user needs to operate the host computer 101 and download the expansion application 204 from a server to the host computer 101 via the Internet and install it. Alternatively, the expansion application 204 may be automatically installed in the host computer 101 in response to the connection of the printing apparatus 102 to the host computer 101. Specifically, when the printing apparatus 102 is connected to the host computer 101, the OS obtains the device identification information from the printing apparatus 102. Further, the OS downloads the expansion application 204 corresponding to the obtained device identification information from the server to the host computer 101 via the Internet and installs the expansion application. That is, the general-purpose print software 202 and the expansion application 204 are stored in the host computer 101 as different files. Alternatively, the expansion application 204 may be installed in the host computer 101 by the CPU 111 of the host computer 101 reading the expansion application 204 stored in the storage medium.

The general-purpose print software 202 and the expansion application 204 may be updated and upgraded, but these update processes are also performed at different timings. That is, the timing at which the host computer 101 obtains the general-purpose print software 202 is different from the timing at which the host computer 101 obtains the expansion application 204. Further, a trigger for the host computer 101 to obtain the general-purpose print software 202 is different from a trigger for the host computer 101 to obtain the expansion application 204. When the expansion application 204 is installed, the OS associates the expansion application 204 with the general-purpose print software 202 and the printing apparatus 102.

As illustrated in FIG. 2B, the expansion application 204 has a print-setting-screen expansion unit 205, a print function expansion unit 206, an intermediate data editing unit 207, a notification unit 208, and a calibration instructing unit 209. The expansion application 204 has shared information 210 that can be accessed in common by the units. An actual state of the shared information 210 is a file saved in the external storage device 114 or information stored in the RAM 113 in the host computer 101. The expansion application 204 writes and reads information to and from the shared information 210 by using an API (Application Program Interface) provided by the OS. The expansion application 204 may end the operation every time the process of each unit is finished. In this case, the OS activates the expansion application 204 every time a request to use each unit is received. Further, the expansion application 204 may cancel the process in the process of each unit. When the process is cancelled, the OS deletes the job in processing on the print queue.

Upon receiving a print request from the user, the drawing application 201 issues a print instruction to the OS. Even in the configuration of FIG. 2B, the drawing application 201 can display the print setting screen as with the configuration of FIG. 2A. Further, in the configuration of FIG. 2B, the advanced setting screen provided by the expansion application 204 is displayed. Specifically, the advanced setting screen provided by the print-setting-screen expansion unit 205 of the expansion application 204 is displayed. The print-setting-screen expansion unit 205 can store information about the advanced setting set by the user (hereinafter, referred to as “advanced setting information”) in the shared information 210. The print-setting-screen expansion unit 205 will be described in detail later.

The intermediate data editing unit 207 obtains intermediate data from the general-purpose print software 202, converts the obtained intermediate data to print data, and then transfers the print data to the printing apparatus 102. Hereinafter, the intermediate data editing unit 207 will be described in detail. When the printing apparatus 102 has the gamma correction function, the intermediate data editing unit 207 converts the intermediate data into the print data without performing the gamma correction. On the other hand, when the printing apparatus 102 does not have the gamma correction function, the intermediate data editing unit 207 obtains the gamma coefficient from the printing apparatus 102, performs the gamma correction on the intermediate data, and converts the intermediate data into the print data. The printing apparatus 102 applies a necessary image process to the received print data and prints on a sheet.

The method of converting the intermediate data into the print data is not limited to the above method. The expansion application 204 may be configured to obtain print data generated by the general-purpose print software 202 and add the advanced setting to the print data. Even in the configuration of FIG. 2B, the calibration setting may not be performed by a user. In this case, the general-purpose print software 202 may transfer the print data to the printing apparatus 102 without passing through the expansion application 204 as with the configuration of FIG. 2A.

The print function expansion unit 206 may edit the PDC 203 generated by the general-purpose print software 202 or the OS. Thus, the print function expansion unit 206 can add a function provided by the expansion application 204 or a function (for example, a calibration function) supported by the printing apparatus 102 but not supported by the general-purpose print software 202. Furthermore, the print function expansion unit 206 can add an exclusive relationship between the set values of the print functions. The OS activates the print function expansion unit 206 when the expansion application 204 is associated with the printing apparatus 102 and the general-purpose print software 202 at first. Further, the OS may activate the print function expansion unit 206 at other timings (for example, at the time of activation of the OS). In this way, in a case where an optional apparatus (for example, a finisher) is added to the printing apparatus 102 later and functions relating to printing are expanded, the print function expansion unit 206 can detect the expanded function and add it to the PDC 203.

The notification unit 208 can display a notification to the user in response to an error occurring in the printing apparatus 102. For example, when a paper empty error occurs in the printing apparatus 102, the general-purpose print software 202 detects the error, and the OS causes the display device 120 to display a message using a notification function called a toast notification, which is a function of the OS. When the user selects the toast notification by the pointing device 119, the notification unit 208 is called by the OS, and a UI screen of the notification unit 208 is displayed. The notification unit 208 can display, for example, a detailed message about the paper empty error and a paper filling method on the UI screen.

The calibration instructing unit 209 obtains the detailed setting information from the shared information 210, and if the calibration is set, transmits a calibration instruction to the printing apparatus 102. The calibration instructing unit 209 obtains the capability information of the printing apparatus 102 from the shared information 210, and determines whether the printing apparatus 102 has the gamma correction function. When the printing apparatus 102 has the gamma correction function, the calibration instructing unit 209 receives a calibration end notification from the printing apparatus 102 upon completion of the calibration operation of the printing apparatus 102, and ends the process.

In contrast, when the printing apparatus 102 does not have the gamma correction function, the calibration instructing unit 209 obtains the gamma coefficient from the printing apparatus 102 and stores the obtained gamma coefficient in the shared information 210. Specifically, when receiving the calibration instruction, for example, the printing apparatus 102 outputs the density patches as illustrated in FIG. 4, reads the output density patches, and generates the gamma coefficient with which the output results (solid line 502) of the patches becomes the target values (broken line 501). When the printing apparatus 102 does not have the gamma correction function, the generated gamma coefficient is transmitted to the expansion application 204 by the printing apparatus 102 and stored in the shared information 210.

Once the expansion application 204 transmits the print data to the printing apparatus 102, the expansion application 204 cannot display a screen such as a guide associated with the print data during the process of each unit. The configuration of the expansion application 204 is not limited to the configuration having all the functions (units) described above, and may have only a part of the functions or may have other functions. The expansion application 204 may be simply referred to as printing software.

As described above, the expansion application 204 has at least one of the following functions. The first is the function of displaying the setting screen (the print-setting-screen expansion unit 205). The second is the function of editing the intermediate data to convert the intermediate data into the print data and adding the advanced setting to the print data (the intermediate data editing unit 207). The third is the function of expanding a function that can be designated by the print data generation software (the print function expansion unit 206). The fourth is the function of displaying a screen in response to the occurrence of an error in the printing apparatus 102 (the notification unit 208).

Next, examples of the print setting screen and the advanced setting screen will be described with reference to FIGS. 6A, 6B, and 6C. FIG. 6A is a view illustrating the print setting screen displayed by the drawing application 201. FIG. 6B is a view illustrating the advanced setting screen displayed in the case of the configuration illustrated in FIG. 2A, that is, the configuration without the expansion application 204. FIG. 6C is a view illustrating the advanced setting screen displayed in the case of the configuration illustrated in FIG. 2B, that is, the configuration having the expansion application 204. The unit or module for displaying the print setting screen is not limited to the above. For example, the print-setting-screen expansion unit 205 may be configured to only generate the display screen. In this case, the print-setting-screen expansion unit 205 transmits the generated display screen to the drawing application 201 via the general-purpose print software 202. The drawing application 201 displays the display screen obtained in this way.

First, the print setting screen illustrated in FIG. 6A will be described. In a control 601, a printer (that is, a printing apparatus) used for printing, a print orientation, and the number of copies can be set by a user. A control 602 is a preview screen, a control 603 is a button for starting printing, and a control 604 is a button for canceling printing. A control 605 is an advanced setting button. When the control 605 is selected, the additional advanced setting screen is displayed by the general-purpose print software 202 or the print-setting-screen expansion unit 205.

Next, the advanced setting screen illustrated in FIG. 6B will be described. FIG. 6B illustrates the additional advanced setting screen that is displayed by the general-purpose print software 202 in the absence of the expansion application 204. In a control 606, a sheet type can be set by a user, and in FIG. 6B indicates that “Plain paper” is set. In a control 607, a sheet size can be set by a user, and FIG. 6B indicates that an “A4” size is set. In a control 608, a sheet feeding port can be set by a user, and FIG. 6B indicates that “Auto” is set. The control 609 is a button for ending the setting. When the control 609 is selected by the pointing device 119, the display screen shifts from the advanced setting screen illustrated in FIG. 6B to the print setting screen illustrated in FIG. 6A.

Next, the advanced setting screen illustrated in FIG. 6C will be described. FIG. 6C illustrates the additional advanced setting screen that is displayed by the print-setting-screen expansion unit 205 in the presence of the expansion application 204. The advanced setting screen in FIG. 6C is constituted by adding a check box 610 to the advanced setting screen in FIG. 6B. The check box 610 is button that allows a user to set the calibration, and in FIG. 6C indicates that the calibration is set.

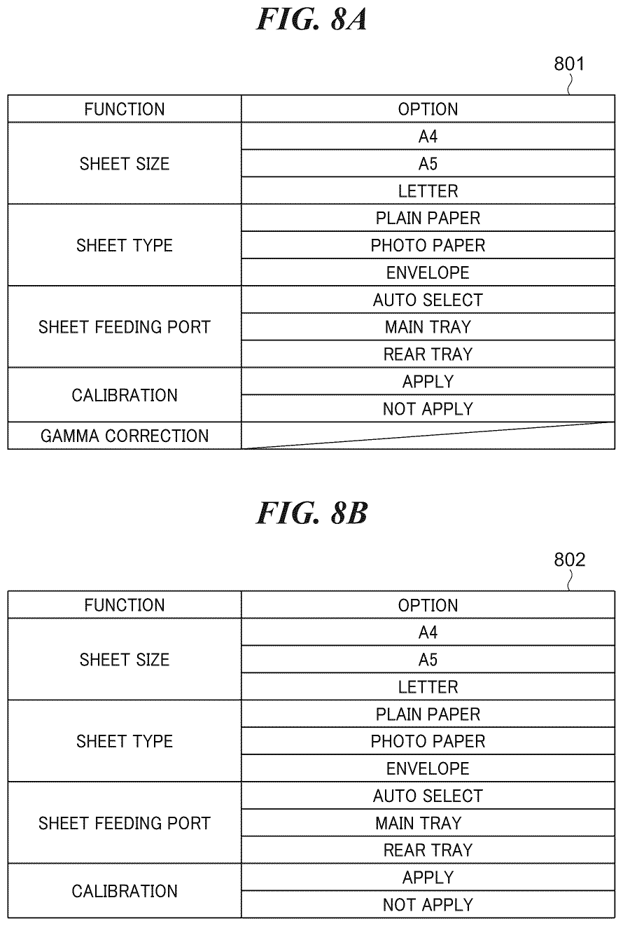

Here, the reason why the print setting items are different between the advanced setting screen in FIGS. 6B and 6C will be described. The advanced setting screen is generated by referring to the PC generated based on the print function information and setting screen display information indicating whether to display functions illustrated in FIGS. 8A and 8B, which will be described later, on the screen. However, since the general-purpose print software 202 does not support the calibration function, the calibration function cannot be added to the print function information. Even if the print function information originally includes the calibration function, the general-purpose print software 202 cannot interpret the calibration function included in the print function information. Therefore, the general-purpose print software 202 cannot display the check box 610 that allows the calibration setting on the advanced setting screen. On the other hand, when the expansion application 204 is provided, the print function expansion unit 206 adds the calibration functions to the PC and the print-setting-screen expansion unit 205 displays the advanced setting screen by referring to the PDC 203 and the setting screen display information. With these configurations, the expansion application 204 can display the check box 610 that allows the calibration setting on the advanced setting screen.

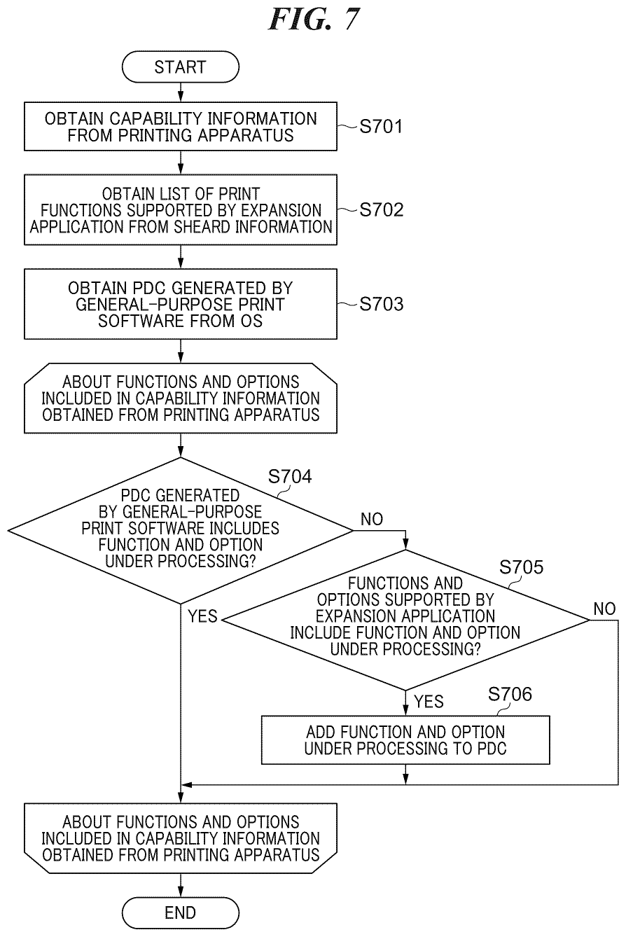

Here, a flow of an editing process of the PDC 203 executed by the print function expansion unit 206 of the expansion application 204 will be described using a flowchart illustrated in FIG. 7. Each step of the flowchart illustrated in FIG. 7 is achieved by the CPU 111 activating the expansion application 204 in the host computer 101. First, in a step S701, the CPU 111 obtains capability information from the printing apparatus 102 by the print function expansion unit 206. The capability information includes attribute information indicating functions that can be designated in the printing apparatus 102 and set values associated with the attribute information, which are included in a response obtained by issuing an IPP Get-Printer-Attributes operation to the printing apparatus 102. FIGS. 8A and 8B are views illustrating examples of lists of capability information obtained from the printing apparatus 102 as tables. A table 801 illustrated in FIG. 8A is an example of a list of capability information in the case where the printing apparatus 102 has the gamma correction function. A table 802 illustrated in FIG. 8B is an example of a list of capability information in a case where the printing apparatus 102 does not have the gamma correction function. The capability information of the printing apparatus 102 is stored in the shared information 210.

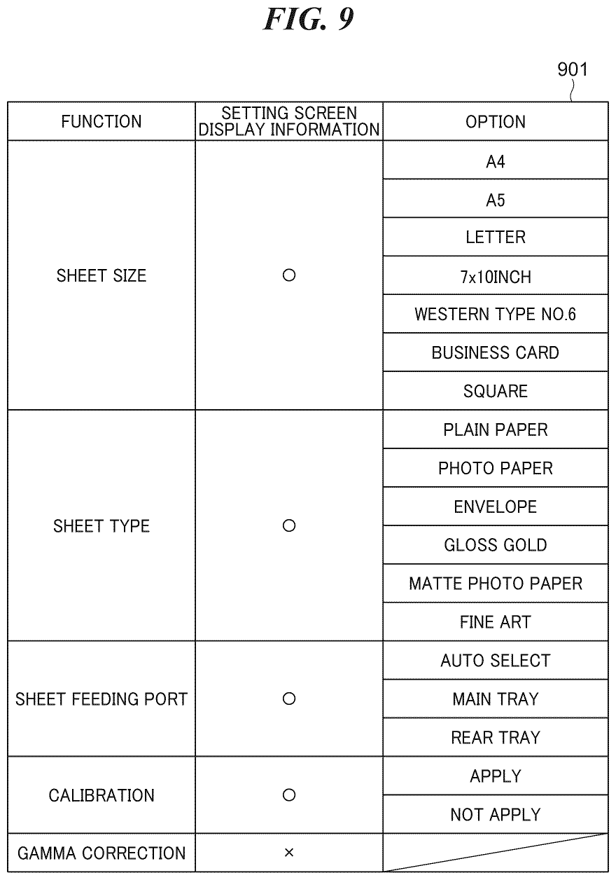

Referring back to the description of FIG. 7. Next, in a step S702, the CPU 111 obtains a list of the print functions supported by the expansion application 204 from the shared information 210 by the print function expansion unit 206. The list of the print functions supported by the expansion application 204 describes all print functions that can be processed by the expansion application 204 and their set values, and is stored in the shared information 210. A table 901 illustrated in FIG. 9 is an example of a list of print functions supported by the expansion application 204. The list of the print functions supported by the expansion application 204 may be updated according to update of the expansion application 204. As illustrated in FIG. 9, the list of the print functions supported by the expansion application 204 also includes the setting screen display information. The setting screen display information is referred to by the print-setting-screen expansion unit 205, and is information indicating whether the respective functions are displayed on the advanced setting screen in FIG. 6C. The reason why the gamma correction is not displayed on the advanced setting screen is that the gamma correction is a function of always correcting an image by the gamma coefficient generated by the calibration function, unlike the function of switching the setting as in the sheet size.

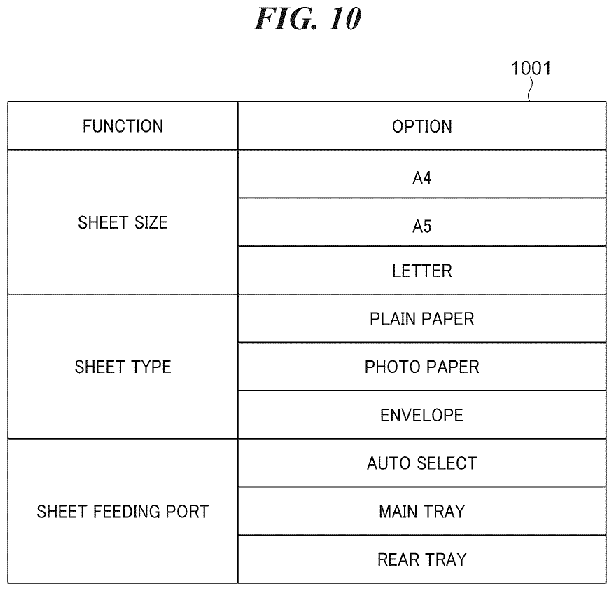

Referring back to the description of FIG. 7. Subsequently, in a step S703, the CPU 111 obtains the PDC 203 generated by the general-purpose print software 202 from the OS by the print function expansion unit 206. A table 1001 illustrated in FIG. 10 is an example of a list of print functions supported by the general-purpose print software 202. The PDC 203 generated by the general-purpose print software 202 is generated based on the table 801 or the table 802 that is the capability information list obtained by the general-purpose print software 202 from the printing apparatus 102. Since only the print functions supported by the general-purpose print software 202 are described in the PDC 203 generated by the general-purpose print software 202 among the capability information obtained from the printing apparatus 102, the print functions of the PDC 203 are limited.

For example, the table 901, which is the list of print functions supported by the expansion application 204, includes options of “7×10 Inch” and “western type No. 6” as the sheet size. However, the general-purpose print software 202 does not support the options of the sheet sizes concerned, and the options of the sheet sizes are not described in the PDC 203. Therefore, the print function expansion unit 206 adds a function or an option to the PDC 203, and thus the expansion application 204 becomes able to supplement the lack of the function of the general-purpose print software 202. The print function expansion unit 206 can also delete unnecessary function and option from the PDC 203 generated by the general-purpose print software 202.

Referring back to the description of FIG. 7. Subsequent steps S704, S705, and S706 are processes repeatedly performed for the list of combinations of functions and options included in the capability information obtained from the printing apparatus 102 in the step S701. That is, the processes in the steps S704, S705, and S706 are repeatedly performed for the list of combinations of functions and options in the tables 801 and 802. First, in the step S704, the CPU 111 determines, by the print function expansion unit 206, whether the combination of function and option under processing are included in the PDC 203 generated by the general-purpose print software 202.

When the CPU 111 determines, by the print function expansion unit 206, that the combination of function and option under processing is included in the PDC 203 generated by the general-purpose print software 202, the process returns to the step S704. At this time, the CPU 111 selects, by the print function expansion unit 206, the next items from the combinations of functions and options of the capability information obtained from the printing apparatus 102 and performs the process in the step S704 again. However, when the CPU 111 determines, by the print function expansion unit 206, that the last item among the combinations of functions and options included in the capability information obtained from the printing apparatus 102 is under processing, the CPU 111 ends the process of the flowchart illustrated in FIG. 7. On the other hand, when the CPU 111 determines, by the print function expansion unit 206, that the combination of function and option under processing is not included in the PDC 203 generated by the general-purpose print software 202, the process proceeds to the step S705.

Specifically, for example, “Sheet size: A4” illustrated in the table 801, which is the capability information list of the printing apparatus 102, is also included in the table 1001, which is the capability information list of the general-purpose print software 202. In this case, the CPU 111 determines, by the print function expansion unit 206, that the combination of function and option under processing is included in the PDC 203 generated by the general-purpose print software 202. In contrast, “Calibration: Apply” illustrated in the table 801, which is the capability information list of the printing apparatus 102, is not included in the table 1001, which is the capability information list of the general-purpose print software 202. In this case, the CPU 111 determines, by the print function expansion unit 206, that the combination of function and option under processing is not included in the PDC 203 generated by the general-purpose print software 202. As a result, the process proceeds to the step S705.

Next, in the step S705, the CPU 111 determines, by the print function expansion unit 206, whether the combination of function and option under processing is included in the combinations of functions and options supported by the expansion application 204. When the CPU 111 determines, by the print function expansion unit 206, that the combination of function and option under processing is included in the combinations of functions and options supported by the expansion application 204, the process proceeds to the step S706.

In contrast, when the CPU 111 determines, by the print function expansion unit 206, that the combination of function and option under processing is not included in the combinations of functions and options supported by the expansion application 204, the process returns to the step S704. At this time, the CPU 111 selects, by the print function expansion unit 206, the next item from among the combinations of functions and options of the capability information obtained from the printing apparatus 102 and performs the process in the step S704 again. However, when the CPU 111 determines, by the print function expansion unit 206, that the last item among the combinations of functions and options included in the capability information obtained from the printing apparatus 102 is under processing, the CPU 111 ends the process of the flowchart illustrated in FIG. 7.

Specifically, for example, when the combination of function and option under processed is “Calibration: Apply”, the combination is also included in the table 901 that is the capability information list of the expansion application 204. In this case, the CPU 111 determines, by the print function expansion unit 206, that the combination of function and option under processing is included in the combinations of functions and options supported by the expansion application 204. As a result, the process proceeds to the step S706.

Subsequently, in the step S706, the CPU 111 adds, by print function expansion unit 206, the combination of function and option under processing to the PDC 203. Thereafter, the process returns to the step S704. At this time, the CPU 111 selects, by the print function expansion unit 206, the next item from among the combinations of functions and options of the capability information obtained from the printing apparatus 102 and performs the process in the step S704 again. However, when the CPU 111 determines, by the print function expansion unit 206, that the last item among the combinations of functions and options included in the capability information obtained from the printing apparatus 102 is under processing, the CPU 111 ends the process of the flowchart illustrated in FIG. 7.

As described above, the CPU 111 adds, by the print function expansion unit 206, the combination of function and option that is not supported by the general-purpose print software 202, is supported by the printing apparatus 102, and is supported by the expansion application 204 to the PDC 203. Specifically, when the capability information list of the printing apparatus 102 is the table 801, three items of “Calibration: Apply”, “Calibration: Not Apply”, and “Gamma correction” are added to the PDC 203. In contrast, when the capability information list of the printing apparatus 102 is the table 802, two items of “Calibration: Apply” and “Calibration: Not apply” are added to the PDC 203, but “Gamma correction” is not added.

The PC is generated on the basis of the PDC 203 edited by such an editing process flow. Further, the print-setting-screen expansion unit 205 generates a display screen based on the generated PC and the setting screen display information. This adds the function that is not supported by the general-purpose print software 202 and selects the option to be displayed. As a result, the advanced setting screen in FIG. 6C can be displayed.

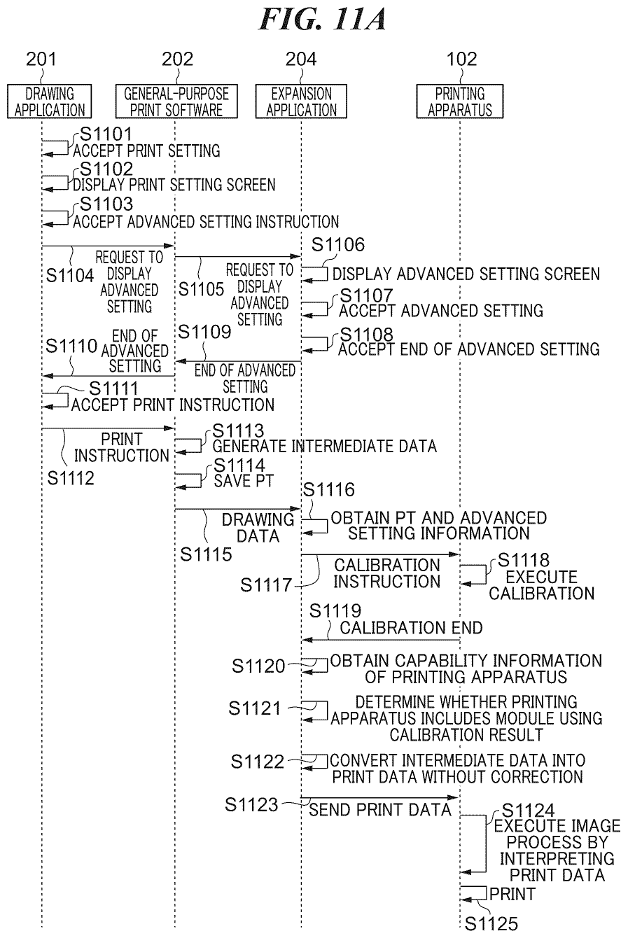

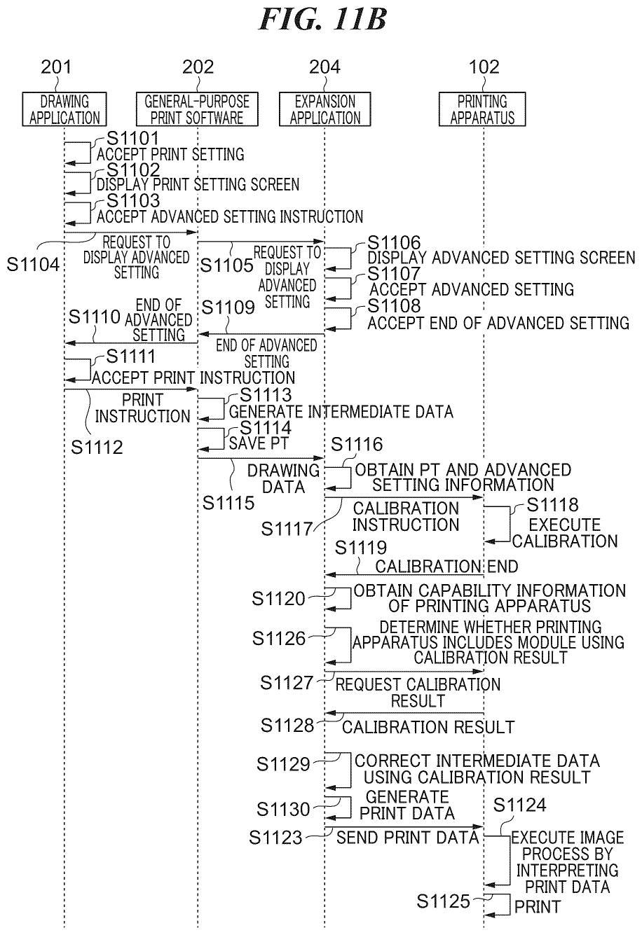

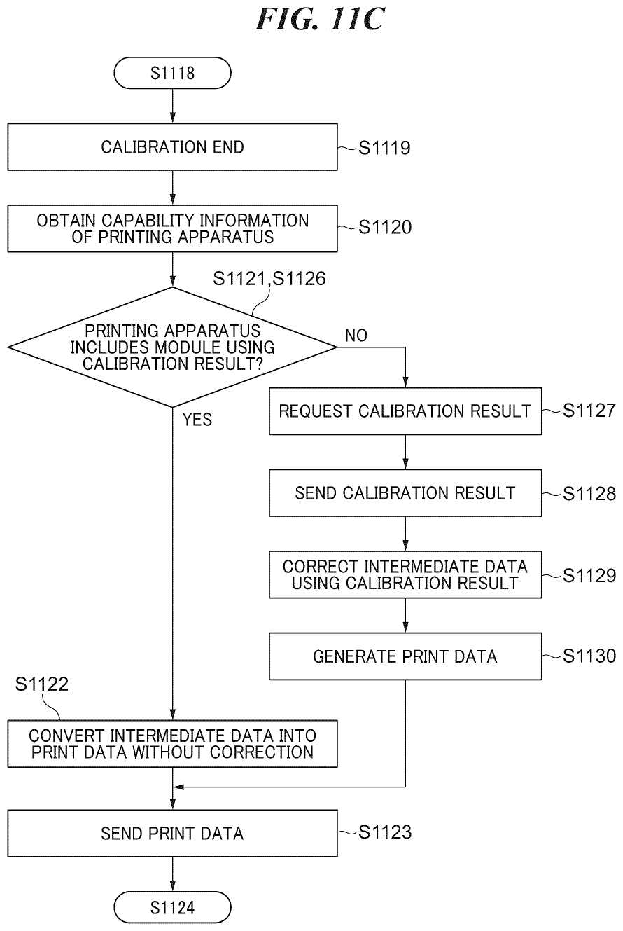

Next, sequences of operations of the drawing application 201, the general-purpose print software 202, the expansion application 204, and the printing apparatus 102 after the drawing application 201 accepts the print setting will be described with reference to FIGS. 11A and 11B. FIG. 11A illustrates the sequence (method) in a case where the capability information list of the printing apparatus 102 is the table 801. FIG. 11B illustrates the sequence (method) in a case where the capability information list of the printing apparatus 102 is the table 802. Steps other than the steps executed by the printing apparatus 102 in FIGS. 11A and 11B are achieved by the CPU 111 (a computer) activating the drawing application 201, the general-purpose print software 202, and the expansion application 204 (programs) in the host computer 101. On the other hand, the steps executed by the printing apparatus 102 in FIGS. 11A and 11B are achieved by the ASIC 135 in the printing apparatus 102, but may be achieved the CPU 131 reading the program stored in the ROM 132 to the RAM 133 and executing the program. The sequences in FIGS. 11A and 11B assume that the software configuration of the print system has the configuration in FIG. 2B.

The sequence in FIG. 11A, that is, the sequence in the case where the capability information list of the printing apparatus 102 is the table 801 will be described. First, in a step S1101, the CPU 111 of the host computer 101 accepts the print setting from a user by the drawing application 201. The user can instruct the drawing application 201 to execute the print setting by operating the keyboard 118 or the pointing device 119. Next, in a step S1102, the CPU 111 displays the print setting screen illustrated in FIG. 6A on the display device 120 by the drawing application 201. Subsequently, in a step S1103, the CPU 111 accepts an advanced setting instruction by the drawing application 201. The user can instruct the advanced setting by selecting the control 605 while operating the pointing device 119.

Next, in a step S1104, the CPU 111 requests, by the drawing application 201, the general-purpose print software 202 to display the advanced setting. Subsequently, in a step S1105, the CPU 111 requests, by the general-purpose print software 202, the expansion application 204 to display the advanced setting. Unlike the assumption, if the software configuration of the print system has the configuration in FIG. 2A, the general-purpose print software 202 displays the advanced setting screen in FIG. 6B on the display device 120 as described above. Next, in a step S1106, the CPU 111 displays the advanced setting screen in FIG. 6C on the display device 120 by the print-setting-screen expansion unit 205 of the expansion application 204. As described in the description about FIG. 6C, the calibration function is added to the PDC 203 by the print function expansion unit 206. Therefore, in the step S1106, the print-setting-screen expansion unit 205 displays the advanced setting screen in FIG. 6C on the display device 120 by referring to the PC generated based on the PDC 203 after the addition and the setting screen display information in FIG. 9.

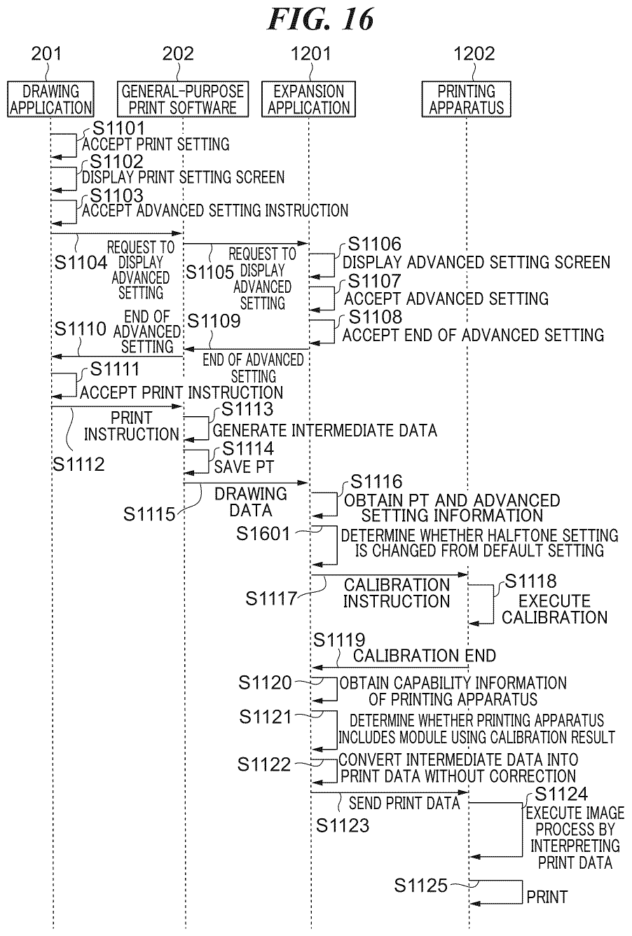

Subsequently, in a step S1107, the CPU 111 (a reception unit) receives the advanced setting by the print-setting-screen expansion unit 205 (a reception process). In the case of the advanced setting screen in FIG. 6C, the print-setting-screen expansion unit 205 accepts that “Sheet type: Plain paper”, “Sheet size: A4”, “Sheet feeding port: Auto”, and “Calibration: Apply” are set by the user. Next, in a step S1108, the CPU 111 accepts the end of the advanced setting by the print-setting-screen expansion unit 205. The user can instruct the end of the advanced setting by selecting the control 609 while operating the pointing device 119. When the advanced setting is completed, the print-setting-screen expansion unit 205 stores the advanced setting information in the shared information 210. The print-setting-screen expansion unit 205 closes the advanced setting screen in FIG. 16C on the display device 120. As a result, the display device 120 displays the print setting screen illustrated in FIG. 6A again.

Subsequently, in a step S1109, the CPU 111 transmits, by the expansion application 204, the end of the advanced setting to the general-purpose print software 202. Next, in a step S1110, the CPU 111 transmits the end of the advanced setting to the drawing application 201 by the general-purpose print software 202. Subsequently, in a step S1111, the CPU 111 accepts a print instruction by the drawing application 201. The user can instruct printing by selecting the control 603 while operating the pointing device 119. Next, in a step S1112, the CPU 111 instructs, by the drawing application 201, the general-purpose print software 202 to print.

Subsequently, in a step S1113, the CPU 111 generates the intermediate data by the general-purpose print software 202. At this time, the general-purpose print software 202 uses a module of the OS. Next, in a step S1114, the CPU 111 stores the PT included in the intermediate data in the shared information 210 by the general-purpose print software 202. Subsequently, in a step S1115, the CPU 111 transfers the drawing data included in the intermediate data to the expansion application 204 by the general-purpose print software 202. Next, in a step S1116, the CPU 111 obtains, by the calibration instruction unit 209 of the expansion application 204, the PT stored in the step S1114 and the advanced setting information stored in the step S1108 from the shared information 210.

Subsequently, in a step S1117, the CPU 111 (an instructing unit) instructs the printing apparatus 102 to perform the calibration by the calibration instruction unit 209 (an instruction step). Next, in a step S1118, the ASIC 135 of the printing apparatus 102 executes the calibration. The calibration is executed according to the calibration process of the flowchart in FIG. 3. Subsequently, in a step S1119, the ASIC 135 of the printing apparatus 102 transmits a calibration end to the calibration instruction unit 209 of the expansion application 204. As a result, the CPU 111 of the host computer 101 receives the calibration end by the calibration instruction unit 209 of the expansion application 204.

Next, in a step S1120, the CPU 111 (a first obtaining unit) obtains the capability information of the printing apparatus 102 from the shared information 210 by the intermediate data editing unit 207 of the expansion application 204 (a first obtaining process). Subsequently, in a step S1121, the CPU 111 determines, by the intermediate data editing unit 207, whether the printing apparatus 102 includes a module using the calibration result. In the first embodiment, the CPU 111 (a determination unit) determines, by the intermediate data editing unit 207, whether the printing apparatus 102 has the gamma correction function from the capability information of the printing apparatus 102 (a determination step). In this regard, FIG. 11A illustrates the sequence in the case where the capability information list of the printing apparatus 102 is the table 801 as described above. Therefore, in the step S1121, the CPU 111 determines, by the intermediate data editing unit 207, that the printing apparatus 102 has the gamma correction function from the capability information of the printing apparatus 102. Next, in a step S1122, the CPU 111 (a first generation unit) converts the intermediate data into the print data without performing the gamma correction by the intermediate data editing unit 207. In this way, the print data is generated (a first generation step). Subsequently, in a step S1123, the CPU 111 (a first sending unit and a second sending unit) sends the print data to the printing apparatus 102 by the intermediate data editing unit 207 (a first sending step and a second sending step).

Next, in a step S1124, the ASIC 135 of the printing apparatus 102 interprets the print data and applies the necessary image process to the image of the print data. For example, when the advanced setting in FIG. 6C is set, the ASIC 135 of the printing apparatus 102 performs the gamma correction with the gamma coefficient generated by the calibration in the step S1118 and a screen process. Next, in a step S1125, the ASIC 135 of the printing apparatus 102 prints the image data generated in the image process in the step S1124. Since the gamma correction is performed in the step S1124, the tone of printed matter matches the target as compared with the case where the gamma correction is not performed. The sequence in the case where the capability information list of the printing apparatus 102 is the table 801, that is, the sequence in the case where the printing apparatus 102 has the gamma correction function has been described above.

Next, the sequence in FIG. 11B, that is, the sequence in the case where the capability information list of the printing apparatus 102 is the table 802 will be described. The steps with the same numeral references in FIG. 11B are the same processes in FIG. 11A, and therefore, the description thereof will be omitted. In a step S1126, the CPU 111 of the host computer 101 determines whether the printing apparatus 102 includes a module that uses the calibration result by using the intermediate data editing unit 207 of the expansion application 204. In the first embodiment, the CPU 111 (a determination unit) determines, by the intermediate data editing unit 207, whether the printing apparatus 102 has the gamma correction function from the capability information of the printing apparatus 102 (a determination step). In this regard, FIG. 11B illustrates the sequence in the case where the capability information list of the printing apparatus 102 is the table 802 as described above. Therefore, in a step S1126, the CPU 111 determines from the capability information of the printing apparatus 102 by the intermediate data editing unit 207 that the printing apparatus 102 does not have the gamma correction function.

Next, in a step S1127, the CPU 111 requests the calibration result (gamma coefficient) from the printing apparatus 102 by the intermediate data editing unit 207. Subsequently, in a step S1128, the ASIC 135 of the printing apparatus 102 sends the calibration result (gamma coefficient) to the intermediate data editing unit 207 of the expansion application 204. Accordingly, the CPU 111 (a second obtaining unit) of the host computer 101 obtains, by the intermediate data editing unit 207 of the expansion application 204, the calibration result (gamma coefficient) (a second obtaining step). Next, in a step S1129, the CPU 111 (a correction unit) causes the intermediate data editing unit 207 to perform the gamma correction on the intermediate data (a correction process) using the calibration result (gamma coefficient). Subsequently, in a step S1130, the CPU 111 (a second generation unit) generates the print data based on the gamma-corrected intermediate data by the intermediate data editing unit 207 (a second generation process). The sequence in the case where the capability information list of the printing apparatus 102 is the table 802, that is, the sequence in the case where the printing apparatus 102 does not have the gamma correction function has been described above.

FIG. 11C is a flowchart in which the flow from the step S1119 to the step S1123 in the sequence charts in FIGS. 11A and 11B is summarized while focusing the expansion application 204. The expansion application 204 performs the process in the step S1119 by the calibration instruction unit 209 thereof. The expansion application 204 performs the process in the step S1120 by the intermediate data editing unit 207 thereof. Further, the expansion application 204 performs the determination process in the step S1121 or the step S1126 by the intermediate data editing unit 207.

At this time, when the expansion application 204 determines, by the intermediate data editing unit 207, that the printing apparatus 102 has the gamma correction function from the capability information of the printing apparatus 102, the processes in the step S1122 and the step S1123 are performed. On the other hand, when the expansion application 204 determines, by the intermediate data editing unit 207, that the printing apparatus 102 does not have the gamma correction function from the capability information of the printing apparatus 102, the processes from the step S1127 to the step S1130 are performed.

As described above, the CPU 111 of the host computer 101 issues the calibration instruction to the printing apparatus 102 by using the calibration instruction unit 209 of the expansion application 204. Further, when the printing apparatus 102 has the gamma function, the CPU 111 converts the intermediate data into the print data without the gamma correction by using the intermediate data editing unit 207 of the expansion application 204, and sends the print data to the printing apparatus 102. On the other hand, when the printing apparatus 102 does not have the gamma correction function, the CPU 111 obtains the gamma coefficient from the printing apparatus 102 by the intermediate data editing unit 207. Further, the CPU 111 converts the intermediate data subjected to the gamma correction using the obtained gamma coefficient into the print data by the intermediate data editing unit 207, and sends the print data to the printing apparatus 102.

The series of processes described above enable to improve the correction performance based on the calibration result by the expansion application 204 that expands the function of the general-purpose print software 202 that can be commonly used among printing apparatuses provided by a plurality of vendors. Even when the printing apparatus 102 does not have the function using the calibration result, the calibration function can be provided to the user without increasing the cost of the printing apparatus 102. That is, the expansion application 204 improves the performance of the correction based on the calibration result when the printing apparatus 102 supported by the general-purpose print software 202 has the function using the calibration result and enables the correction when the function concerned is not provided.

Although the calibration instruction is given in both the sequences in FIGS. 11A and 11B, when the check box 610 is not checked, non-execution information indicating that the calibration is not performed is included in the advanced setting information. In this case, when the CPU 111 of the host computer 101 detects the non-execution information from the advanced setting information obtained in the step S1116 by the calibration instruction unit 209 of the expansion application 204, the process in the step S1117 is not performed.

In addition, although the advanced setting screen in FIG. 6C is displayed on the display device 120 on the premise that the print system has the software configuration in FIG. 2B in the first embodiment, this is not limiting. For example, when display of the advanced setting is requested in the step S1104, the CPU 111 of the host computer 101 may display the advanced setting screen of FIG. 6B on the display device 120 by the general-purpose print software 202. In this case, after the setting on the advanced setting screen in FIG. 6B is completed, the CPU 111 requests, by the general-purpose print software 202, the expansion application 204 to display an additional advanced setting screen. Further, the CPU 111 additionally displays the advanced setting screen in FIG. 6C in which the calibration setting can be set by the print-setting-screen expansion unit 205 of the expansion application 204.

In the first embodiment, the CPU 111 of the host computer 101 generates print data based on the intermediate data generated by the general-purpose print software 202 by the intermediate data editing unit 207 of the expansion application 204. However, the CPU 111 may generate the intermediate data by the intermediate data editing unit 207 itself and generate the print data based on the generated intermediate data.

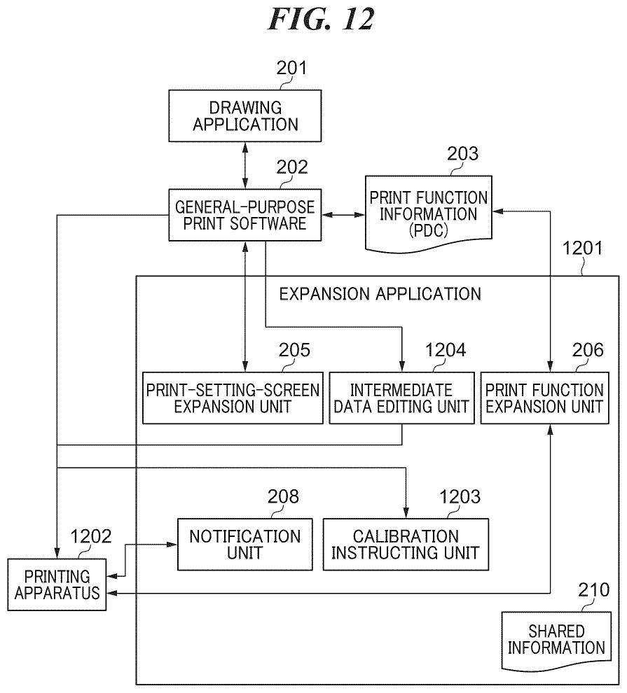

A second embodiment will now be described with reference to FIGS. 12 to 16. In the first embodiment, the calibration is set by the user first, and the print instruction is issued. Subsequently, the CPU111 of the host computer 101 sends the calibration instruction to the printing apparatus 102 by the expansion application 204, and causes the printing apparatus 102 to execute the calibration. Next, the CPU 111 switches the process according to the capability information of the printing apparatus 102 by the expansion application 204.

Specifically, when the printing apparatus 102 has the gamma correction function, the CPU 111 converts, by the expansion application 204, the intermediate data into the print data without the correction and sends the print data to the printing apparatus 102 to cause the printing apparatus 102 to perform the gamma correction. On the other hand, when the printing apparatus 102 does not have the gamma correction function, the CPU 111 causes the expansion application 204 to perform the gamma correction on the intermediate data using the gamma coefficient obtained from the printing apparatus 102. Further, the CPU 111 sends the print data generated based on the intermediate data subjected to the gamma correction to the printing apparatus 102 by the expansion application 204.

In the first embodiment, as described above, the calibration instruction is performed only when the calibration setting is set by the user. However, even when the calibration setting is not set by the user, it is preferable to perform the calibration in some cases. For example, it is a case where a halftone option (screen ruling) is changed. When the halftone option is changed and the screen ruling is changed, the density of halftone dots changes and the dot reproducibility varies, and therefore the gamma characteristics do not match. Therefore, there is a possibility that the gamma coefficient of the screen before the change cannot be used. Therefore, when the halftone option is changed, it is preferable that the calibration setting is automatically set, the gamma coefficient corresponding to the changed halftone option are generated, and the gamma correction is performed with the generated gamma coefficient.

Thus, in the second embodiment, the expansion application first determines whether the halftone has been changed from a default setting. Then, when the halftone has been changed from the default setting, the expansion application sends a calibration instruction to the printing apparatus. As a result, in printing using the standard driver, even when the calibration setting is not set although the current print setting requires the calibration, a printed matter in which the characteristic unique to the printing apparatus is corrected can be always provided to a user. In addition, similarly to the first embodiment, the expansion application switches whether to perform the gamma correction on the intermediate data according to the capability information of the printing apparatus, and thus it is possible to improve the correction performance. Even when the printing apparatus does not have the gamma correction function, it becomes possible to provide the calibration function to the user.

The following description of the second embodiment is focused on the differences from the first embodiment. The same configurations and processes as those of the first embodiment are denoted by the same reference numerals in FIGS. 12 to 16 and the descriptions thereof will be omitted because they have been already described in the first embodiment. The second embodiment is different from the first embodiment in five points, that is, the software configuration of the print system, the capability information of the printing apparatus, the print function of the expansion application, the advanced setting screen, and the sequence after the drawing application receives the print setting.

FIG. 12 is a view illustrating the software configuration of the print system when an expansion application 1201 is associated with the general-purpose print software 202 and a printing apparatus 1202. The printing apparatus 1202 can switch a halftone process between high screen ruling and low screen ruling. The expansion application 1201 includes the print-setting-screen expansion unit 205, the print function expansion unit 206, the notification unit 208, the shared information 210, a calibration instruction unit 1203, and an intermediate data editing unit 1204.

The calibration instruction unit 1203 determines whether the halftone has been changed from the default setting, and if the halftone has been changed from the default setting, issues a calibration instruction to the printing apparatus 1202. The intermediate data editing unit 1204 generates a print data from the intermediate data based on the set halftone option with reference to the advanced setting information. Thus, the halftone which is not provided in the standard driver is reflected to the print data, and the printing apparatus 1202 can perform the image process with the set halftone option. The hardware configuration of the printing apparatus 1202 is the same as that of the printing apparatus 102 in the first embodiment.

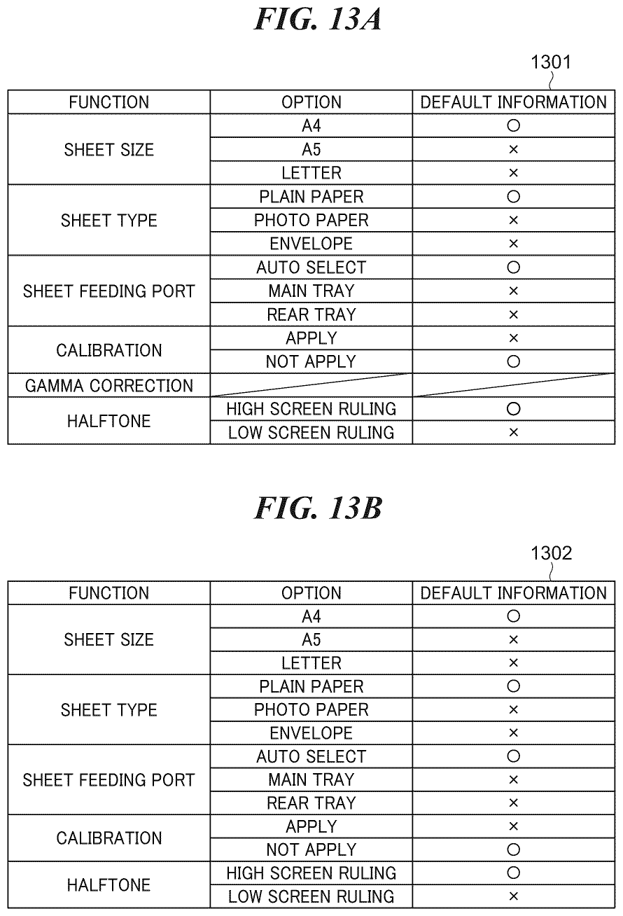

The capability information of the printing apparatus 1202 will be described with reference to FIGS. 13A and 13B. FIGS. 13A and 13B are views illustrating examples of lists of the capability information obtained from the printing apparatus 1202 as tables. A table 1301 illustrated in FIG. 13A is an example of a list of capability information when the printing apparatus 1202 has the gamma correction function. A table 1302 illustrated in FIG. 13B is an example of a list of capability information in a case where the printing apparatus 1202 does not have the gamma correction function. The capability information of the printing apparatus 1202 is stored in the shared information 210. The tables 1301 and 1302 are obtained by adding a halftone function and default information to the tables 801 and 802 of the first embodiment.

The default information indicates an option that is initially set for each function when the print setting screen or the advanced setting screen is displayed on the display device 120. For example, in the case of the table 1301, “Not Apply” is the default for the calibration function. It is preferable that the calibration is not executed every time of printing unless a print instruction is issued to change the unique characteristics of the printing apparatus 1202. The reason is that, as described with reference to FIG. 3, the calibration requires processes, such as output of the density pattern 401, reading, and generation of the gamma coefficient, and thus an extra time is required until actual printing.

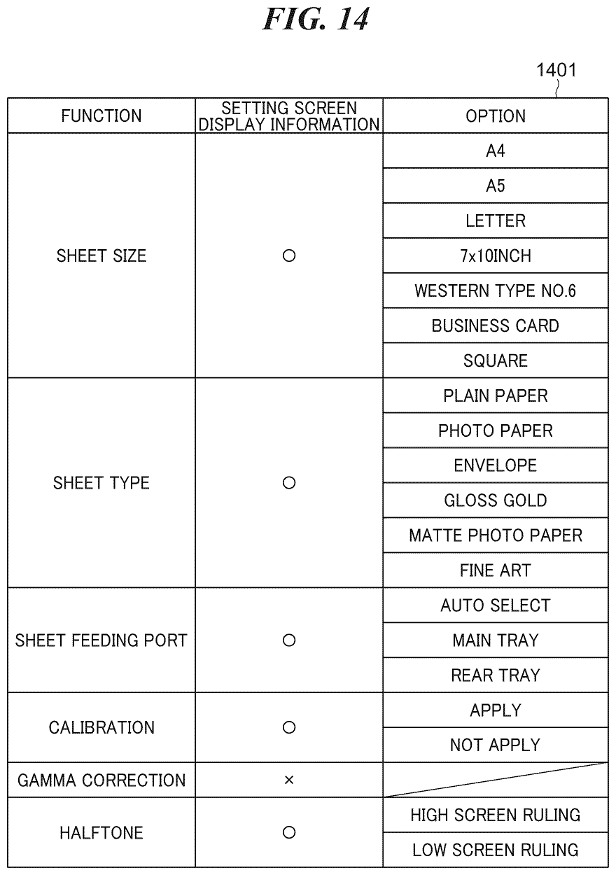

A list of print functions supported by the expansion application 1201 will be described with reference to FIG. 14. A table 1401 illustrated in FIG. 14 is an example of a list of print functions supported by the expansion application 1201. As illustrated in the table 1401, the halftone function is added to the PDC 203 through the flowchart of the editing process in FIG. 7 by associating the halftone function with the expansion application 1201. Thus, the halftone function can be displayed on the advanced setting screen. Further, the print data in which the halftone is reflected to the intermediate data generated by the general-purpose print software 202 is generated, and thus the printing apparatus 1202 can perform the image process with the set option of the halftone.

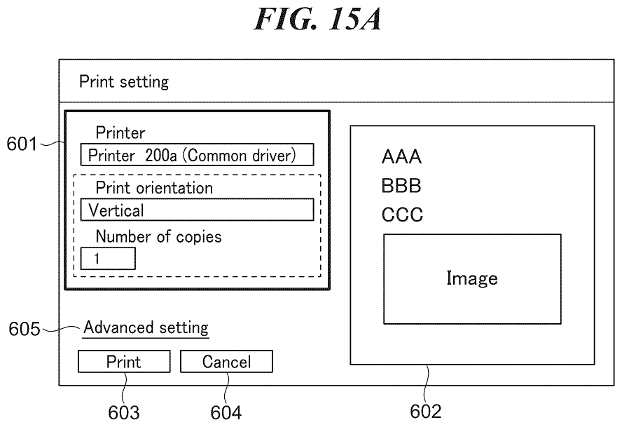

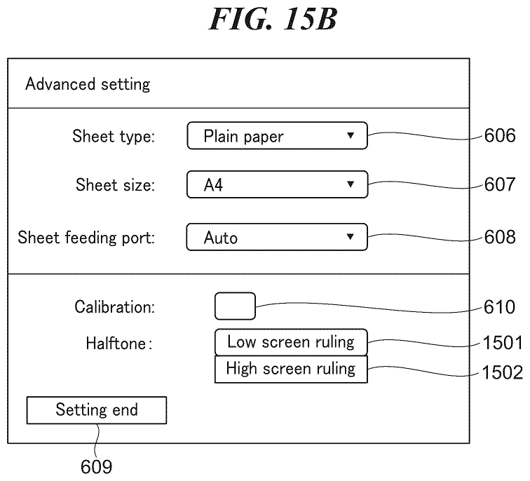

Next, examples of the print setting screen and advanced setting screen will be described with reference to FIGS. 15A and 15B. FIG. 15A is similar to FIG. 6A and is a view showing the print setting screen displayed by the drawing application 201. FIG. 15B is a view showing the advanced setting screen displayed by the expansion application 1201. The advanced setting screen in FIG. 15B is a screen in which a control 1501 and a list 1502 for the halftone are added to the advanced setting screen in FIG. 6C. In the advanced setting screen in FIG. 15B, the control 1501 indicates that the low screen ruling is set for the halftone option that is changed from the default setting. The list 1502 is displayed when the user selects the control 1501 by using the pointing device 119, and indicates other options that can be set for the halftone. Further, the check box 610 is not checked, which indicates that the calibration is not set by the user.

Next, a sequence of operations of the drawing application 201, the general-purpose print software 202, the expansion application 1201, and the printing apparatus 1202 after the drawing application 201 accepts the print setting will be described with reference to FIG. 16. FIG. 16 illustrates the sequence (method) in a case where the capability information list of the printing apparatus 1202 is the table 1301, and the settings illustrated in FIGS. 15A and 15B are set as the print setting and advanced setting. Steps other than the steps executed by the printing apparatus 102 in FIG. 16 are achieved by the CPU 111 activating the drawing application 201, the general-purpose print software 202, and the expansion application 1201 (programs) in the host computer 101. On the other hand, the steps executed by the printing apparatus 1202 in FIG. 16 are implemented by the ASIC 135 in the printing apparatus 1202, but may be implemented by the CPU 131 reading the program stored in the ROM 132 to the RAM 133 and executing the program.

The sequence in FIG. 16 is obtained by adding a process in a step S1601 to the sequence in FIG. 11A. However, in the step S1107, the CPU 111 of the host computer 101 accepts the following advanced setting by the print-setting-screen expansion unit 205. In the case of the advanced setting screen in FIG. 15B, the print-setting-screen expansion unit 205 accepts the settings set by the user including “Sheet type: Plain paper”, “Sheet size: A4”, “Sheet feeding port: Auto”, “Calibration: Not apply”, and “Halftone: Low screen ruling”.

In a step S1601, the CPU 111 determines, by the calibration instruction unit 1203 of the expansion application 1201, whether the halftone has been changed from the default setting based on the advanced setting information. In this regard, FIG. 16 illustrates the sequence in a case where the settings illustrated in FIGS. 15A and 15B are set as the print setting and the detail setting as described above. When the settings illustrated in FIGS. 15A and 15B are set, the halftone is changed from the high screen ruling as the default setting to the low screen ruling. Therefore, in the step S1601, the CPU 111 determines that the halftone has been changed from the default setting by the calibration instruction unit 1203 based on the detailed setting information.

However, as described above, this case has high possibility that the gamma characteristic is different from that in the case of the high screen ruling. Therefore, even if the calibration instruction unit 1203 detects non-execution information indicating that the calibration is not performed from the detailed setting information, the CPU 111 issues the calibration instruction to the printing apparatus 1202 in the step S1117. The sequence in the case where the capability information list of the printing apparatus 1202 is the table 1301 and the settings illustrated in FIGS. 15A and 15B are set as the print setting and the advanced setting has been described above. When the capability information list of the printing apparatus 1202 is the table 1302 and the printing apparatus 1202 does not have the gamma correction function, the sequence is the same as that in FIG. 16 up to the step S1119, and the sequence is the same as that in FIG. 11B from the step S1120.

The series of processes described above enable to improve the correction performance based on the calibration result by the expansion application 1201 that expands the function of the general-purpose print software 202 that can be commonly used among printing apparatuses provided by a plurality of vendors. Even when the printing apparatus 1202 does not have the function using the calibration result, the calibration function can be provided to the user without increasing the cost of the printing apparatus 1202. That is, the expansion application 1201 improves the performance of the correction based on the calibration result when the printing apparatus 1202 supported by the general-purpose print software 202 has the function using the calibration result and enables the correction when the function concerned is not provided.

Further, in the second embodiment, even when the advanced setting for not performing the calibration is set, when the option of the printing function requiring the calibration is changed, the calibration instruction is issued. Specifically, even when the check box 610 is not checked and the advanced setting for not performing the calibration is set, when the halftone option, which is a print function requiring the calibration, has been changed, the calibration instruction is issued. In this way, in the second embodiment, even when the advanced setting for not performing the calibration is set, the printed matter in which the characteristic unique to the printing apparatus 1202 is corrected can be always provided to the user. Further, since the calibration instruction is issued only when the option of the printing function requiring the calibration is changed, and the calibration instruction is not issued every time of printing, it is possible to suppress the unnecessary calibration instruction.

In the second embodiment, the CPU 111 of the host computer 101 instructs the calibration by the calibration instruction unit 1203 of the expansion application 1201 when it is determined that the halftone has been changed from the default setting. However, the CPU 111 may cause the printing apparatus 1202 to hold the halftone option and the gamma coefficient in association with each other, and issue the calibration instruction by the calibration instruction unit 1203 when the current halftone option is different from the held one. When a setting of an option of a function (for example, the sheet type) for changing the characteristic unique to the printing apparatus 1202 other than the halftone is changed, the CPU 111 may issue the calibration instruction by the calibration instruction unit 1203.

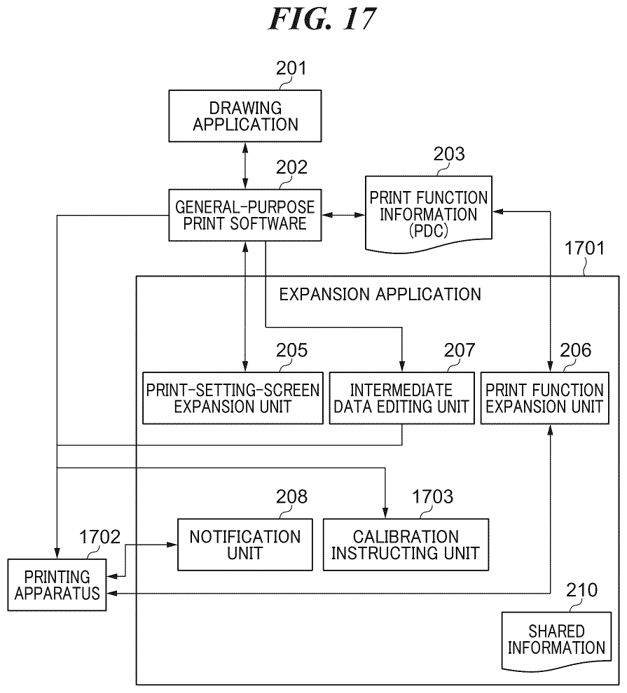

A third embodiment will now be described with reference to FIGS. 17 to 22. In the first and second embodiments, the calibrations of the printing apparatuses 102 and 1202 are completed without requiring a user operation. In this regard, there are a plurality of methods for calibration performed in the printing apparatus. For example, as in the first and second embodiment, there is the calibration method in which the density patches are output to the intermediate transfer belt of the printing apparatus or a sheet and the density patches are read by the sensor in the printing apparatus. Such a method does not require a user operation.

In addition, there is a calibration method in which density patches are output to a sheet by a printing apparatus, the sheet is discharged, and the sheet is scanned by a reader attached to the printing apparatus to read the density patches. In such a method, user operations, such as setting of the sheet to the reader and an instruction of scanning, are required. When a user goes to the printing apparatus after the print instruction, it is preferable that printing has already been completed and the user can obtain a printed matter. However, if the calibration requiring a user operation is set, a user must perform the calibration operation before the printed matter is obtained, which is inconvenient. Further, the user obtains the printed matter after waiting for completion of the calibration after the calibration operation is performed. Therefore, extra time is required to obtain the printed matter.

Therefore, in the third embodiment, the expansion application determines whether the calibration requiring an actual machine operation has been set. When the calibration requiring the actual machine operation is set, the expansion application displays a warning screen for urging a user to change the setting to the calibration not requiring the actual machine operation. Thus, when the user changes the setting to the calibration in which the actual machine operation is unnecessary, it is possible to provide the calibration function without causing the user to take extra time and effort in the printing using the standard driver. In addition, similarly to the first and second embodiments, since the expansion application switches whether to perform the gamma correction on the intermediate data according to the capability information of the printing apparatus, and thus it is possible to improve the correction performance. Even when the printing apparatus does not have the gamma correction function, it becomes possible to provide the calibration function to the user.

The following description of the third embodiment is focused on the differences from the first embodiment. The same configurations and processes as those of the first embodiment are denoted by the same reference numerals in FIGS. 17 to 22 and the descriptions thereof will be omitted because they have been already described in the first embodiment. The third embodiment is different from the first embodiment in six points, that is, the software configuration of the print system, the capability information of the printing apparatus, the printing function of the expansion application, the advanced setting screen, the sequence after the drawing application receives the print setting, and a warning screen. In the third embodiment, the configuration related to the halftone in the second embodiment may be provided to perform the process related to the halftone in second embodiment.

FIG. 17 is a view showing a software configuration of a print system in which an expansion application 1701 is associated with the general-purpose print software 202 and a printing apparatus 1702. The printing apparatus 1702 is equipped with a plurality of calibration methods. The printing apparatus 1702 is equipped with a calibration method that does not require an actual machine operation of a user, such as outputting the density patches to the intermediate transfer belt and reading the output density patches with the sensor. Further, the printing apparatus 1702 is also equipped with a calibration method in which the density patches output to the sheet is read by the reader by the actual machine operation of user. Hereinafter, the calibration method that does not require an actual machine operation of a user is also referred to as “simple calibration”, and the calibration that requires an actual machine operation of a user is also referred to as “fine calibration”.

The expansion application 1701 also includes the print-setting-screen expansion unit 205, the print function expansion unit 206, the intermediate data edit unit 207, the notification unit 208, the shared information 210, and a calibration instructing unit 1703. The calibration instructing unit 1703 displays a warning screen for a user when the calibration requiring the actual machine operation of a user is set. Further, the user can change the setting of the calibration to a setting that does not require the actual machine operation of the user, or can accept that the calibration that requires the actual machine operation of the user is set, on the warning screen. The hardware configuration of the printing apparatus 1702 is the same as that of the printing apparatus 102 in the first embodiment.

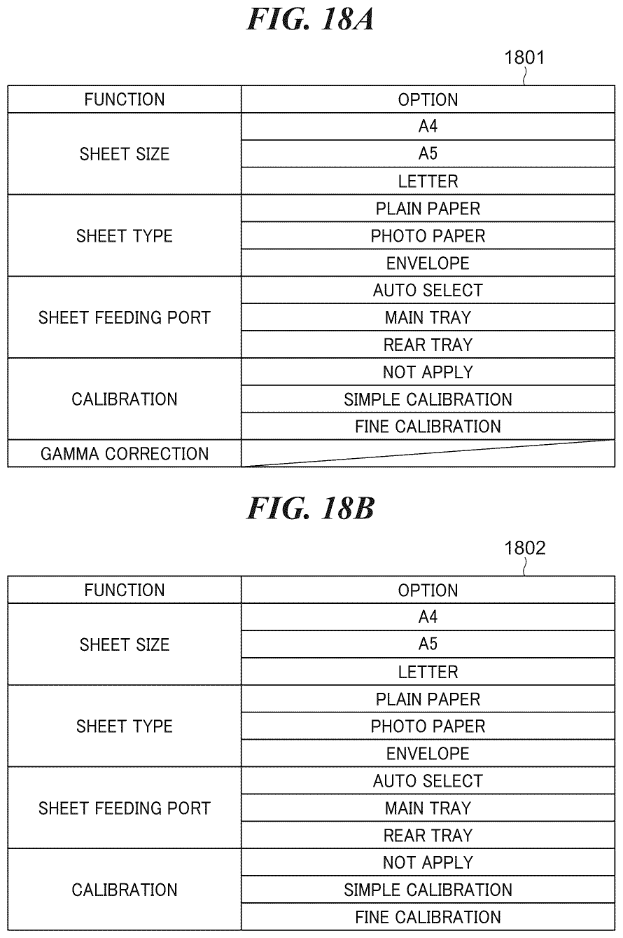

The capability information of the printing apparatus 1702 will be described with reference to FIGS. 18A and 18B. FIGS. 18A and 18B are views illustrating examples of lists of capability information obtained from the printing apparatus 1702 as tables. A table 1801 illustrated in FIG. 18A is an example of a list of capability information in the case where the printing apparatus 1702 has the gamma correction function. A table 1802 illustrated in FIG. 18B is an example of a list of capability information in a case where the printing apparatus 1702 does not have the gamma correction function. The capability information of the printing apparatus 1702 is stored in the shared information 210. The tables 1801 and 1802 are obtained by replacing the option “Apply” of the calibration in the tables 801 and 802 in the first embodiment with the options “simple calibration” and “fine calibration”.

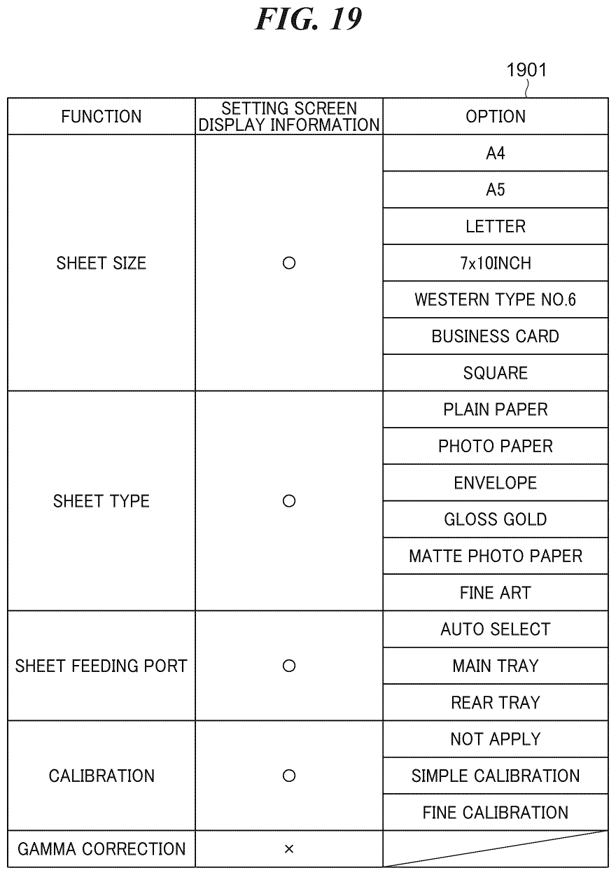

A list of printing functions supported by the expansion application 1701 will be described with reference to FIG. 19. A table 1901 illustrated in FIG. 19 is an example of a list of print functions supported by the expansion application 1701. As illustrated in the table 1901, the function of the calibration is added to the PDC 203 through the flowchart of the editing process in FIG. 7 by associating the options of the simple calibration and the fine calibration with the expansion application 1701. This enables the calibration function to be displayed on the advanced setting screen.

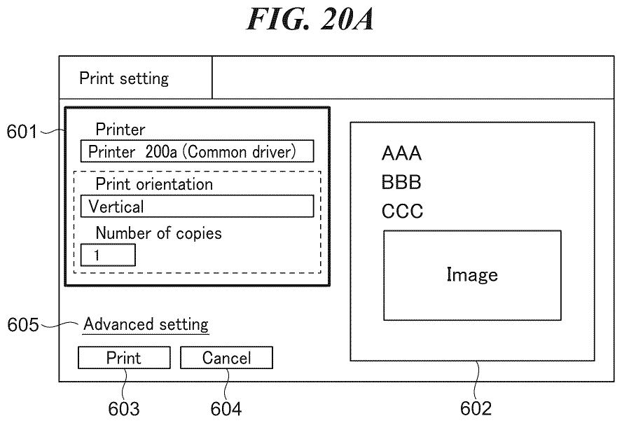

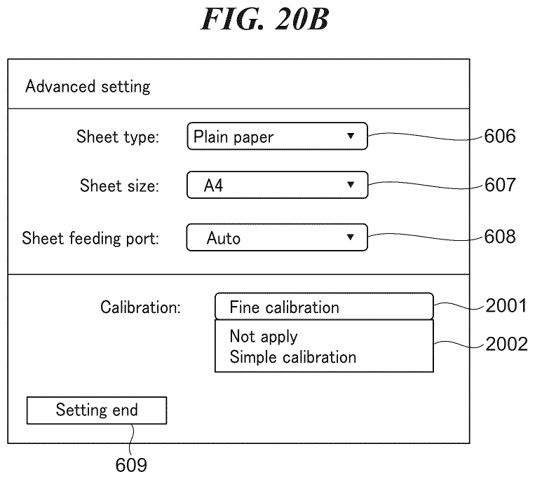

Next, examples of the print setting screen and the advanced setting screen will be described with reference to FIG. 20A and FIG. 20B. FIG. 20A is similar to FIG. 6A and is a view illustrating the print setting screen displayed by the drawing application 201. FIG. 20B is a view illustrating the advanced setting screen displayed by the expansion application 1701. The advanced setting screen in FIG. 20B is provided with a control 2001 and a list 2002 for the calibration instead of the check box 610 in the advanced setting screen in FIG. 6C. The control 2001 in the advanced setting screen in FIG. 20B indicates that the fine calibration is set as the option of the calibration. The list 2002 is displayed when the user selects the control 2001 by using the pointing device 119 and indicates other options that can be set for the calibration.

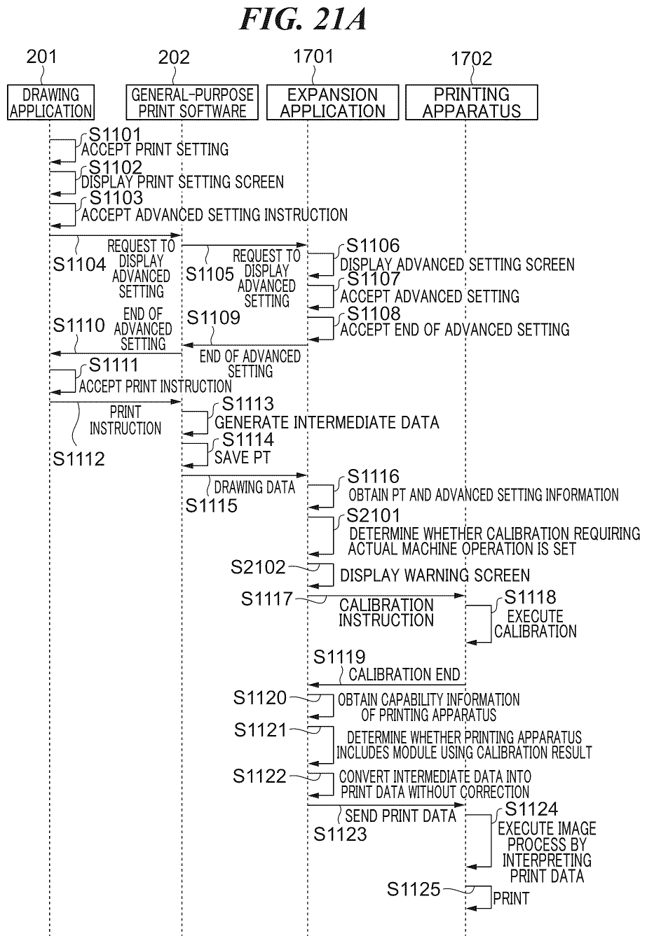

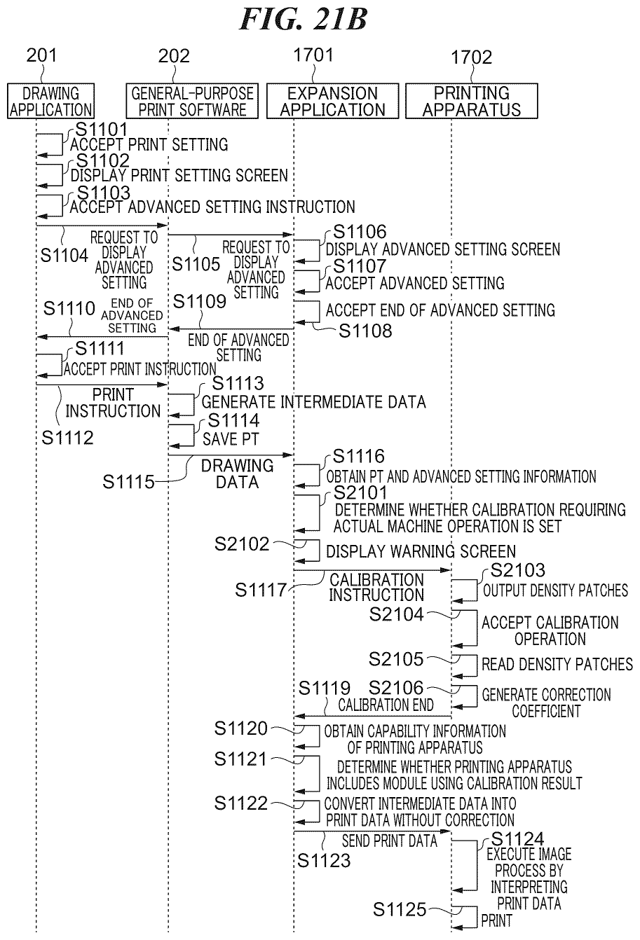

Next, sequences of operations of the drawing application 201, the general-purpose print software 202, the expansion application 1701, and the printing apparatus 1702 after the drawing application 201 accepts the print setting will be described with reference to FIGS. 21A and 21B. FIG. 21A illustrates the sequence (method) in a case where the capability information list of the printing apparatus 1702 is the table 1801, the calibration is set with the option of the fine calibration, and a “Yes” button is selected on a warning screen described below. FIG. 21B illustrates the sequence (method) in a case where the capability information list of the printing apparatus 1702 is the table 1801, the calibration is set with the option of the fine calibration, and a “No” button is selected on the warning screen described below.

Steps other than the steps executed by the printing apparatus 1702 in FIGS. 21A and 21B are achieved by the CPU 111 activating the drawing application 201, the general-purpose print software 202, and the expansion application 1701 (programs) in the host computer 101. On the other hand, the steps executed by the printing apparatus 1702 in FIGS. 21A and 21B are implemented by the ASIC 135 in the printing apparatus 1702, but may be implemented by the CPU 131 reading the program stored in the ROM 132 to the RAM 133 and executing the program.

The sequence in FIG. 21A is obtained by adding processes in steps S2101 and S2102 to the sequence in FIG. 11A. In the step S2101, the CPU 111 of the host computer 101 determines, by the calibration instructing unit 1703 of the expansion application 1701, whether the option of the calibration requiring the actual machine operation has been set based on the advanced setting information. In this regard, FIG. 21A illustrates the sequence in the case where the calibration is set with the option of the fine calibration as described above. Therefore, in the step S2101, the CPU 111 determines, by the calibration instructing unit 1703, that the option of the calibration requiring the real machine operation is set. Next, in the step S2102, the CPU 111 displays the warning screen on the display device 120 by the calibration instructing unit 1703.

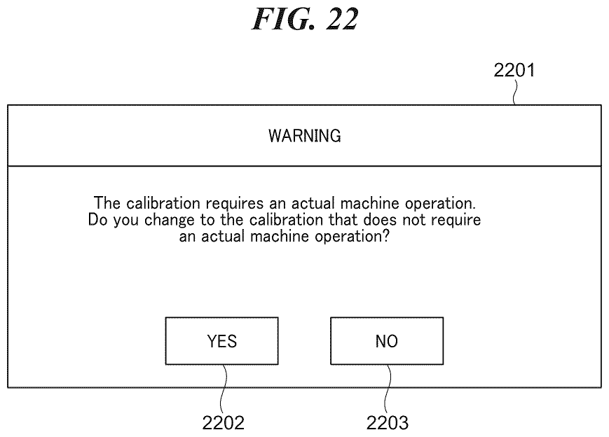

The warning screen will be described below with reference to FIG. 22. FIG. 22 is a view illustrating an example of the warning screen 2201 displayed on the display device 120. The warning screen 2201 displays a message indicating that an actual machine operation of a user is required before printing. The warning screen 2201 further includes a first control 2202 and a second control 2203. The first control 2202 is a “Yes” button for a user to change the option of the calibration to the simple calibration that does not require the actual machine operation of the user. The second control 2203 is a “No” button for a user to agree that the option of the calibration is set in the fine calibration requiring the actual machine operation of the user.

As described above, FIG. 21A illustrates the sequence in the case where the first control 2202 (“Yes” button) is selected on the warning screen 2201. Therefore, in the sequence in FIG. 21A, the processes from the step S1117 are executed in the same manner as in the sequence in FIG. 11A. The above is the description of the sequence in the case where the list of capability information of the printing apparatus 1702 is the table 1801, the calibration is set with the option of the fine calibration, and the first control 2202 (“Yes” button) is selected on the warning screen 2201. When the capability information list of the printing apparatus 1702 is the table 1802, the sequence is the same as that in FIG. 11A up to the step S1119, and the sequence is the same as that in FIG. 11B form the step S1120.

The sequence of FIG. 21B is obtained by adding processes in the steps S2101 and S2102 to the sequence in FIG. 11A and further replacing the process in the step S1118 with processes in steps S2103 to S2106. The descriptions of the steps S2101 and S2102 has already been given in the description of the sequence in FIG. 21A, and therefore will be omitted. FIG. 21B illustrates the sequence in the case where the second control 2203 (“No” button) is selected on the warning screen 2201 as described above. Therefore, in the sequence in FIG. 21B, processes in the steps S2103 to S2106 are executed in place of the process in the step S1118 in the sequence in FIG. 21A.

In the step S2103, the ASIC 135 of the printing apparatus 1702 outputs the density patches. Thus, the density patches are printed on a sheet. Subsequently, in the step S2104, the ASIC 135 of the printing apparatus 1702 accepts the calibration operations by the user. The calibration operations by the user include an operation to set the sheet on which the density patches are printed to the reader and an operation to instruct the reader to scan the sheet. Next, in the step S2105, the ASIC 135 of the printing apparatus 1702 scans the sheet with the reader and reads the density patches. Subsequently, in the step S2106, the ASIC 135 of the printing apparatus 1702 generates gamma coefficient that matches the target values. Thereafter, in the sequence in FIG. 21B, the respective processes from the step S1119 are executed in the same manner as in the sequence in FIG. 21A. The above is the description of the sequence in the case where the capability information list of the printing apparatus 1702 is the table 1801, the calibration is set with the option of the fine calibration, and the second control 2203 (“No” button) is selected on the warning screen 2201. When the capability information list of the printing apparatus 1702 is the table 1802, the sequence is the same as that in FIG. 21B up to the step S1119 and the sequence is the same as that in FIG. 11B from the step S1120.

The series of processes described above enable to improve the correction performance based on the calibration result by the expansion application 1701 that expands the function of the general-purpose print software 202 that can be commonly used among printing apparatuses provided by a plurality of vendors. Even when the printing apparatus 1702 does not have the function using the calibration result, the calibration function can be provided to the user without increasing the cost of the printing apparatus 1702. That is, the expansion application 1701 improves the performance of the correction based on the calibration result when the printing apparatus 1702 supported by the general-purpose print software 202 has the function using the calibration result and enables the correction when the function concerned is not provided.

Further, in the third embodiment, when the option of the calibration requiring the actual machine operation of the user is set, the user is warned by the warning screen 2201 and is prompted to change the setting to the option of the calibration not requiring the actual machine operation of the user. Thus, when the setting is changed to the calibration not requiring the actual machine operation of the user, it is possible to provide the calibration function without causing the user to take extra time and effort in the printing using the standard driver.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-017707, filed Feb. 8, 2024, which is hereby incorporated by reference herein in its entirety.

What is claimed is:

1. A non-transitory computer-readable storage medium storing an application program causing a computer of an information processing apparatus, which executes general-purpose print software capable of generating print data printable by printing apparatuses provided by different vendors, to execute a control method comprising:
accepting setting related to calibration;
instructing a printing apparatus connected to the information processing apparatus to execute the calibration in accordance with the setting related to the calibration;
obtaining capability information of the printing apparatus;
determining whether the printing apparatus includes a module that uses a result of the calibration based on the capability information of the printing apparatus;
generating print data based on intermediate data generated by the general-purpose print software without correcting the intermediate data in a case where the printing apparatus includes a module that uses the result of the calibration;
generating print data based on corrected intermediate data that is obtained by correcting the intermediate data using the result of the calibration obtained from the printing apparatus in a case where the printing apparatus does not include a module that uses the result of the calibration; and
sending the print data generated to the printing apparatus.

2. The non-transitory computer-readable storage medium according to claim 1, wherein the result of the calibration is a correction coefficient for correcting characteristic unique to the printing apparatus.

3. The non-transitory computer-readable storage medium according to claim 2, wherein the correction coefficient is a gamma coefficient.

4. The non-transitory computer-readable storage medium according to claim 1, wherein the control method further comprises:
accepting a setting related to a function that changes a characteristic unique to the printing apparatus;
determining whether the setting related to the function that changes the characteristic unique to the printing apparatus has been changed; and
instructing the printing apparatus to execute the calibration in a case where the setting related to the function that changes the characteristic unique to the printing apparatus is changed regardless of the setting related to the calibration accepted.

5. The non-transitory computer-readable storage medium according to claim 4, wherein the setting related to the function that changes the characteristic unique to the printing apparatus is a setting related to halftone.

6. The non-transitory computer-readable storage medium according to claim 5, wherein the case where the setting related to the function that changes the characteristic unique to the printing apparatus is changed is a case where a default setting of the halftone is changed.

7. The non-transitory computer-readable storage medium according to claim 1, wherein the control method further comprises:
determining whether the calibration related to the setting accepted requires an actual machine operation of a user; and
displaying a warning screen in a case where the calibration related to the setting accepted requires the actual machine operation of the user.

8. The non-transitory computer-readable storage medium according to claim 7, wherein the warning screen includes a first control for the user to change the calibration related to the setting accepted to a calibration that does not require the actual machine operation of the user, and a second control for the user to agree that the calibration related to the setting accepted requires the actual machine operation of the user.

9. A method performed by an information processing apparatus executing general-purpose print software capable of generating print data printable by printing apparatuses provided by different vendors, the method comprising:
accepting setting related to calibration;
instructing a printing apparatus connected to the information processing apparatus to execute the calibration in accordance with the setting related to the calibration;
obtaining capability information of the printing apparatus;
determining whether the printing apparatus includes a module that uses a result of the calibration based on the capability information of the printing apparatus;
generating print data based on intermediate data generated by the general-purpose print software without correcting the intermediate data in a case where the printing apparatus includes a module that uses the result of the calibration;
generating print data based on corrected intermediate data that is obtained by correcting the intermediate data using the result of the calibration obtained from the printing apparatus in a case where the printing apparatus does not include a module that uses the result of the calibration; and
sending the print data generated to the printing apparatus.

10. An information processing apparatus executing general-purpose print software capable of generating print data printable by printing apparatuses provided by different vendors, the information processing apparatus comprising:
a memory device that stores a set of instructions; and
at least one processor that executes the set of instructions to:
accept setting related to calibration;
instruct a printing apparatus connected to the information processing apparatus to execute the calibration in accordance with the setting related to the calibration;
obtain capability information of the printing apparatus;
determine whether the printing apparatus includes a module that uses a result of the calibration based on the capability information of the printing apparatus;
generate print data based on intermediate data generated by the general-purpose print software without correcting the intermediate data in a case where the printing apparatus includes a module that uses the result of the calibration;
generate print data based on corrected intermediate data that is obtained by correcting the intermediate data using the result of the calibration obtained from the printing apparatus in a case where the printing apparatus does not include a module that uses the result of the calibration; and
send the print data generated to the printing apparatus.
